(19) United States
(12) Patent Application Publication
(10) Pub. No.: US 2024/0418597 A1
(43) Pub. Date: Dec. 19, 2024

(54) DAMPING TEST SYSTEMS FOR WOOD-BASED MATERIALS BASED ON FULL SAMPLING OF FREE VIBRATION CURVES

(71) Applicant: CENTRAL SOUTH UNIVERSITY OF FORESTRY AND TECHNOLOGY, Changsha (CN)

(72) Inventors: Zhifeng WANG, Changsha (CN); Zhongfeng ZHANG, Changsha (CN); Licheng ZHOU, Changsha (CN); Da WANG, Changsha (CN); Aijun CHEN, Changsha (CN); Haolei WANG, Changsha (CN); Xin FENG, Changsha (CN)

(73) Assignee: CENTRAL SOUTH UNIVERSITY OF FORESTRY AND TECHNOLOGY, Changsha (CN)

(21) Appl. No.: 18/597,842

(22) Filed: Mar. 6, 2024

(30) Foreign Application Priority Data
Jun. 16, 2023 (CN) 202310716192.5

(51) Int. Cl. G01M 7/02

(52) U.S. Cl. CPC G01M 7/022

(57) ABSTRACT

Disclosed is a damping test system for a wood-based material based on full sampling of a free vibration curve, comprising: a damping test device, a carrying space, a processor, and a storage module. The processor is configured to generate a test scheme and execute a test corresponding to the test scheme; obtain a labeled test scheme; determine, based on the labeled test scheme, test data of the labeled test scheme; determine, based on the test data, whether an extended test is added; in response to determining that the extended test is added, adjust, based on the test data obtained from the storage module, a sampling frequency of a data monitoring module, and determine a test parameter of a newly added extended test; generate, based on the test parameter of the newly added extended test and an adjusted sampling frequency, a new test scheme.

### CROSS-REFERENCE TO RELATED APPLICATION

This application claims priority of Chinese Application No. 202310716192.5, filed on Jun. 16, 2023, the entire contents of which are hereby incorporated by reference.

### TECHNICAL FIELD

The present disclosure relates to the technical field of measurement of damping properties of materials, and in particular to a damping test system for a wood-based material based on full sampling of a free vibration curve.

### BACKGROUND

An amplitude is a basis for calculating damping properties, and the accuracy of the obtained amplitude depends not only on a sampling rate of collected data, the higher the sampling rate is, the closer the obtained amplitude is to an actual amplitude, but also depends on other parameters, such as the coupling of a sensor to the material, irregularities of the material, electrical noise, etc., all of which may affect the accuracy of the amplitude. According to the method of calculating the damping properties, the conventional time-domain attenuation method uses only a portion of amplitude peaks to calculate the damping properties, ignoring the information about the damping properties included in all other sampling points on a free vibration curve. Therefore, for wood and wood-based materials, the conventional time-domain attenuation method cannot accurately measure the damping properties.

Therefore, it is desirable to provide a damping test system for a wood-based material based on full sampling of a free vibration curve, which helps to measure the damping properties of the wood-based material more accurately and reliably.

### SUMMARY

One or more embodiments of the present disclosure provide a damping test system for a wood-based material based on full sampling of a free vibration curve. The damping test system may comprise a damping test device, a carrying space, a processor, and a storage module. The damping test device may be located in the carrying space. The damping test device may include a viscoelasticity test module, a force application module, and a data monitoring module. The viscoelasticity test module may include at least a single degree of freedom system formed based on a predetermined model. The wood-based material may be arranged on the pre-determined model. The processor may be integrated in a processing terminal. The processor may be configured to: generate a test scheme and execute a test corresponding to the test scheme, the test including an initial test and/or an extended test; obtain a labeled test scheme, the labeled test scheme indicating that the test corresponding to the test scheme is executed; determine, based on the labeled test scheme, test data of the labeled test scheme, the test data including at least a logarithmic attenuation value of the labeled test scheme; determine, based on the test data, whether the extended test is added; in response to determining that the extended test is added, adjust, based on the test data obtained from the storage module, a sampling frequency of the data monitoring module, determine a test parameter of a newly added extended test, and send the sampling frequency and the test parameter to the storage module for storage, the test parameter of the newly added extended test including at least one of a material parameter of a model hardware and a disturbance parameter of the force application module, and the material parameter of the model hardware including at least one of an elastic coefficient of a spring and a damping coefficient of a damper; and generate, based on the test parameter of the newly added extended test and an adjusted sampling frequency, a new test scheme, the new test scheme being configured to perform a damping test on the wood-based material.

One or more embodiments of the present disclosure provide a damping test method for a wood-based material based on full sampling of a free vibration curve. The damping test method may comprise: sampling a free vibration of a wood-based material arranged on a predetermined model in a vibration direction to obtain monitoring data, the wood-based material and the predetermined model forming a single degree of freedom system; obtaining, based on the monitoring data, a predetermined vibration curve of the wood-based material; determining, based on the predetermined vibration curve, data to be analyzed; fitting based on the data to be analyzed to obtain a spiral curve; and performing a linear regression analysis of a natural logarithm of a radius of the spiral curve and time to determine a damping ratio of the wood-based material.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic structural diagram of a damping test system for a wood-based material based on full sampling of a free vibration curve according to some embodiments of the present disclosure;

FIG. 2 is a flowchart illustrating an exemplary damping test method for a wood-based material based on full sampling of a free vibration curve according to some embodiments of the present disclosure;

FIG. 3 is a flowchart illustrating an exemplary process of determining a logarithmic attenuation value according to some embodiments of the present disclosure;

FIG. 4 is a schematic diagram illustrating an exemplary process of determining a test parameter of a newly added extended test according to some embodiments of the present disclosure;

FIG. 5 is a schematic diagram illustrating an exemplary analysis data determination model according to some embodiments of the present disclosure;

FIG. 6 is a schematic diagram illustrating an exemplary viscoelasticity damping model according to some embodiments of the present disclosure;

FIG. 7 is a schematic diagram illustrating an exemplary typical dynamic response according to some embodiments of the present disclosure;

FIG. 8 is a schematic diagram illustrating an exemplary dynamic response of a medium density fiberboard (MDF) in a phase plane according to some embodiments of the present disclosure;

FIG. 9 is a schematic diagram illustrating an exemplary damping test system according to some embodiments of the present disclosure;

FIG. 10 is a schematic diagram illustrating an exemplary typical free vibration curve of an MDF according to some embodiments of the present disclosure; and

FIG. 11 is a schematic diagram illustrating an exemplary damping test based on full sampling according to some embodiments of the present disclosure.

### DETAILED DESCRIPTION

In order to more clearly illustrate the technical solutions of the embodiments of the present disclosure, the following briefly introduces the drawings that need to be used in the description of the embodiments. Apparently, the accompanying drawings in the following description are only some examples or embodiments of the present disclosure, and those skilled in the art can also apply the present disclosure to other similar scenarios according to the drawings without creative efforts. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, parts, portions or assemblies of different levels. However, the words may be replaced by other expressions if other words can achieve the same purpose.

As indicated in the disclosure and claims, the terms “a”, “an” and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

Some embodiments of the present disclosure provide a damping test system for a wood-based material based on full sampling of a free vibration curve, which utilizes all the sample points on the vibration curve to measure the damping properties by calculating a logarithmic attenuation value, thereby being more accurate in measurement of the damping properties of the wood-based material.

In some embodiments, the damping test system for the wood-based material based on full sampling of the free vibration curve may be applied to various fields for measuring damping ratios, and determine the damping effect or damping properties of various materials and structures by testing and evaluating the damping properties of the various materials and structures. For example, in the construction industry, the damping test system of the present disclosure may be configured to evaluate the damping properties of a building structure to ensure the stability and safety of the building. As another example, in the construction industry, the damping test system of the present disclosure may be configured to evaluate the vibration damping properties and ride comfort of a vehicle. As another example, in the musical instrument manufacturing industry, the damping test system of the present disclosure may be configured to evaluate the vibration properties of a musical instrument, or the like.

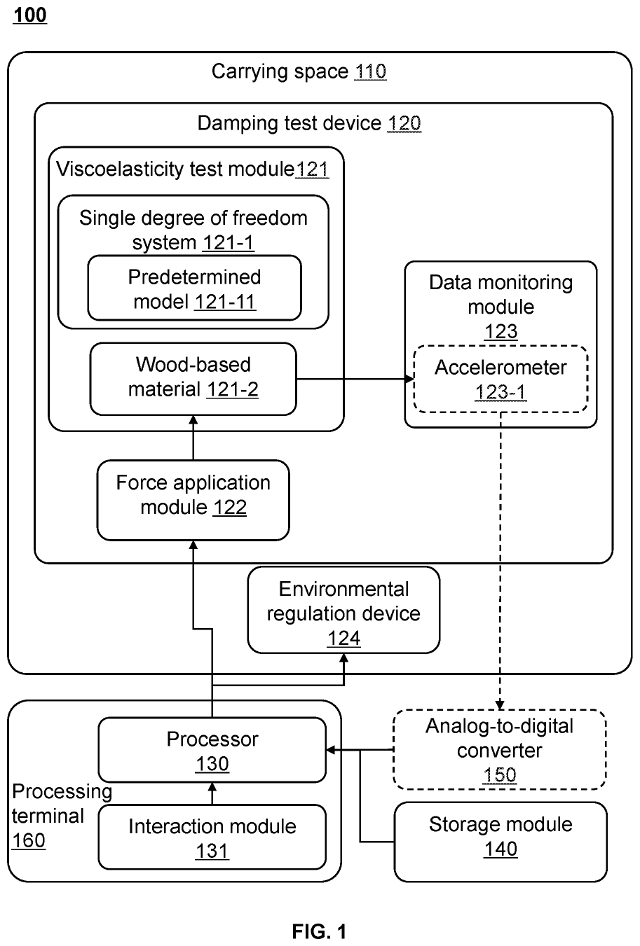

FIG. 1 is a schematic structural diagram illustrating a damping test system for a wood-based material based on full sampling of a free vibration curve according to some embodiments of the present disclosure.

As illustrated in FIG. 1, a damping test system 100 for a wood-based material based on full sampling of a free vibration curve may comprise: a carrying space 110, a damping test device 120, a processor 130, and a storage module 140.

The carrying space 110 may be configured to form an operating area for performing a damping test. In some embodiments, the damping test device 120 may be arranged in the operating area formed by the carrying space 110 to monitor a free vibration state (e.g., an acceleration, a displacement, and a sound signal) of a wood-based material 121-2 during use. The processor 130 and the storage module 140 may be arranged outside the carrying space 110 to prevent collisions among various structures during a movement of the wood-based material 121-2.

In some embodiments, the carrying space 110 refers to a carrying container with a certain strength, stiffness, and specification. For example, the carrying space 110 may be a fixed container. The carrying space 110 may also be portable, facilitating the damping test in various environments.

The damping test device 120 may be configured to measure and test damping properties of a material, a structure, or a system. The damping properties refer to an ability of a material to reduce an amplitude or speed of a vibration by absorbing and dissipating energy in case of the vibration or an impact. For example, the damping properties include parameters such as an intrinsic frequency, a damping coefficient, a damping ratio, or a damping loss factor, etc.

In some embodiments, the damping test device 120 may apply an external excitation to the wood-based material 121-2 to cause a free vibration of the wood-based material 121-2, and monitor a real-time acceleration, a displacement, a sound signal, or the like, of the wood-based material 121-2 in a free vibration process.

In some embodiments, the damping test device 120 may include a viscoelasticity test module 121, a force application module 122, and a data monitoring module 123.

The viscoelasticity test module 121 is a device for measuring the damping properties based on a viscous damping that the wood-based material 121-2 is subjected to during the free vibration process. The viscous damping is a damping suffered by an object moving at a low speed in a fluid or sliding along a lubricated surface. T viscous damping is linearly correlated with a movement speed of the object.

In some embodiments, the viscoelasticity test module 121 may be a single pendulum, a spring oscillator, or the like.

In some embodiments, the viscoelasticity test module 121 may include at least a single degree of freedom system 121-1 formed based on a predetermined model 121-11.

The single degree of freedom system 121-1 refers to a system whose position is fully determined based on a generalized coordinate, such as the single pendulum, the spring oscillator, or the like. The generalized coordinate is configured to describe a position and movement of an object on a line or curve.

In some embodiments, the single degree of freedom system 121-1 may include an undamped free vibration system or a damped free vibration system.

The predetermined model 121-11 refers to a system for describing viscous and elastic behaviors of a material. For example, the predetermined model may include a Kelvin-Voigt model, or the like.

In some embodiments, the predetermined model 121-11 may be configured to measure a dynamic response of the wood-based material 121-2 under the external excitation.

In some embodiments, the predetermined model 121-11 may include an elastic element (e.g., a spring) and a damping element (e.g., a damper) connected in series. The elastic element represents the elastic behavior of the wood-based material 121-2, and the damping element represents the viscous behavior of the wood-based material 121-2. During a vibration process, a stiffness of the elastic element and a damping of the damping element may determine the dynamic response of the wood-based material 121-2. The dynamic response refers to a change in a vibration state of the wood-based material 121-2 from an onset to a termination of the vibration state under the external excitation.

In some embodiments, one end of the predetermined model 121-11 may be suspended from the top within the carrying space 110, and the other end of the predetermined model 121-11 may be connected with the wood-based material 121-2. In this case, the wood-based material 121-2 may, by the gravity of the wood-based material 121-2, exert a pull force on the elastic element and the damping element. The connection may include a mechanical connection, bonding, etc.

In some embodiments, the predetermined model 121-11 may also be connected at another location in the carrying space 110. For example, the predetermined model 121-11 may also be connected with a bottom of the carrying space 110. Correspondingly, the wood-based material 121-2 may, by the gravity of the wood-based material 121-2, exert the pull force on the elastic element and the damping element. As another example, the predetermined model 121-11 may also be connected with a side wall of the carrying space 110. Correspondingly, the elastic element and the damping element may not be subjected to force without the external excitation.

In some embodiments, in the single degree of freedom system 121-1 formed based on the predetermined model 121-11, the wood-based material 121-2 may perform a damped free vibration by applying the external excitation to the wood-based material 121-2.

The wood-based material 121-2 refers to a material made of wood.

In some embodiments, the wood-based material 121-2 may be a block (e.g., a square and a cuboid). In some embodiments, the wood-based material 121-2 may also be spherical or other shapes.

In some embodiments, the wood-based material 121-2 may include at least one of solid wood, an MDF, a particle board, a wood-plastic composite material, glued wood, and a bamboo wood fiberboard.

In some embodiments of the present disclosure, by arranging different types of wood-based materials 121-2 to determine corresponding damping properties, the applicability and accuracy of the damping test system may be further verified, thereby improving the reliability of the determined logarithmic attenuation value.

In some embodiments, a length of the wood-based material 121-2 may be within a range of 600-2400 mm, a width of the wood-based material 121-2 may be within a range of 30-60 mm, and a thickness of the wood-based material 121-2 may be within a range of 15-30 mm.

In some embodiments of the present disclosure, by setting an appropriate size of the wood-based material, the situation that the wood-based material is too large to vibrate freely in the carrying space 110, or the wood-based material is too small to cause the free vibration, which results in insufficient monitoring data can be prevented.

The force application module 122 refers to a device that applies the external excitation to the wood-based material to cause the free vibration of the wood-based material.

In some embodiments, the force application module 122 may be a robotic arm, an exciter, or the like. In some embodiments, the external excitation may be a stepwise excitation.

In some embodiments, the force application module 122 may apply a vertical push or pull force to the wood-based material to cause the free vibration of the wood-based material in a vertical direction.

The data monitoring module 123 refers to a device for detecting the vibration state of the wood-based material. For example, the data monitoring module 123 may include an accelerometer 123-1, a fiber optic displacement sensor, a laser tracker, or the like. Correspondingly, the data monitoring module 123 may measure an acceleration of the wood-based material through the accelerometer 123-1, and measure a free vibration displacement of the wood-based material through the fiber optic displacement sensor, the laser tracker, or the like.

In some embodiments, the accelerometer 123-1 may be installed on a side of the wood-based material opposite to a stressed side.

The stressed side refers to a side of the wood-based material that is subjected to the external excitation. The side of the wood-based material opposite to the stressed side refers to a location spatially opposite to the stressed side. For example, the stressed side may be a bottom of the wood-based material, and the side of the wood-based material opposite to the stressed side may be a top of the wood-based material.

In some embodiments, the accelerometer 123-1 may be connected with the processor 130 through an analog-to-digital converter 150. The accelerometer 123-1 may send the measured acceleration of the wood-based material during the free vibration process to the processor 130 through the analog-to-digital converter 150.

The analog-to-digital converter 150 refers to a device that converts analog monitoring data to digital monitoring data. The analog monitoring data is information represented by a continuously changing physical quantity. The digital monitoring data is information represented by discrete sample points. The sample points are discrete values that the analog-to-digital converter 150 samples and composes from the continuous monitoring data.

In some embodiments, the accelerometer 123-1 may measure the acceleration of the wood-based material during the free vibration process in real time. The processor 130 may obtain the acceleration measured by the accelerometer 123-1 through the analog-to-digital converter 150 on a periodic or real-time basis.

In some embodiments, the damping test system 100 may further comprise an interaction module 131.

The interaction module 131 may be configured to interact with a user. The user refers to a person performing the damping test. For example, the user may be a lab technician, a manager, or the like.

In some embodiments, the interaction module 131 may be configured to push prompting information to the user and obtain an operation feedback from the user. In some embodiments, the interaction module 131 may include input components and output components, such as a button, a touch senso, a control level, a keypad, a microphone, a display, or the like.

In some embodiments, the interaction module 131 may be integrated or included in a processing terminal 160.

An environmental regulation device 124 may be configured to regulate a parameter of an internal environment of the carrying space. The parameter of the environment may include at least one of a temperature, a humidity, a vacuum, or the like, of the internal environment of the carrying space. For example, the environmental regulation device 124 may include a temperature regulation device, a humidity regulation device, a vacuuming device, or the like. The temperature regulation device may include a heater, a refrigerator, or the like. The humidity regulation device may include a dehumidifier and a humidifier. The humidifier may increase the humidity of the internal environment of the carrying space. The vacuuming device may include a vacuum pump or the like.

In some embodiments, the environmental regulation device 124 may further include one or more sensors. The one or more sensors may include a temperature sensor, a humidity sensor, a vacuum gauge, or the like. The environmental regulation device 124 may obtain the temperature, the humidity, and a vacuum degree inside the carrying space based on the temperature sensor, the humidity sensor, and the vacuum gauge.

In some embodiments, the processor 130 may be in communicating connection with the environmental regulation device 124 to send an environmental regulation parameter to the environmental regulation device 124 to control an operation of the environmental regulation device 124, thereby adjusting the internal environment of the carrying space 110.

The processor 130 refers to a system with a computing capability, such as a computer, an industrial control machine, a computing cloud platform, or the like. In some embodiments, the processor 130 may include one or more sub-processors, such as a central processing unit (CPU), a graphics processing unit (GPU), or the like, or any combination thereof

In some embodiments, the processor 130 may obtain data and/or information from the force application module 122, the data monitoring module 123, the environmental regulation device 124, or the like, of the damping test system 100 for the wood-based material based on full sampling of the free vibration curve. The processor 130 may execute program instructions based on the data, the information, and/or processing results to implement one or more functions described in embodiments of the present disclosure.

In some embodiments, the processor 130 may be in communicating connection with the force application module 122, the data monitoring module 123, the environmental regulation device 124, the interaction module 131, or the like. The processor 130 may be configured to control the damping test system 100 for the wood-based material based on full sampling of the free vibration curve to: generate a test scheme and execute a test corresponding to the test scheme, the test including an initial test and/or an extended test; obtain a labeled test scheme, the labeled test scheme indicating that the test corresponding to the test scheme is executed; determine, based on the labeled test scheme, test data of the labeled test scheme, the test data including at least a logarithmic attenuation value of the labeled test scheme; determine, based on the test data, whether the extended test is added; in response to determining that the extended test is added, adjust, based on the test data obtained from the storage module 140, a sampling frequency of the data monitoring module, determine a test parameter of a newly added extended test, and send the sampling frequency and the test parameter to the storage module for storage, the test parameter of the newly added extended test including at least one of a material parameter of a model hardware and a disturbance parameter of the force application module, and the material parameter of the model hardware including at least one of an elastic coefficient of a spring and a damping coefficient of a damper; and generate, based on the test parameter of the newly added extended test and an adjusted sampling frequency, a new test scheme, the new test scheme being configured to perform a damping test on the wood-based material.

In some embodiments, the damping test system 100 for the wood-based material based on full sampling of the free vibration curve may include a network and/or other components connecting the damping test system 100 to external resources. The processor 130 may access data and/or information related to the damping test system 100 via the network.

In some embodiments, the damping test system 100 for the wood-based material based on full sampling of the free vibration curve may further include the processing terminal 160. The processing terminal 160 refers to one or more terminal devices used by the user. The processor 130 may be integrated in the processing terminal 160.

The storage module 140 may be configured to store data, instructions, and/or any other information. For example, the storage module 140 may store the test data, or the like. In some embodiments, the storage module 140 may include a random access memory (RAM), a read-only memory (ROM), a mass memory, a removable memory, a volatile read/write memory, or the like, or any combination thereof. In some embodiments, the storage module 140 may be integrated or included in one or more other components (e.g., the processor 130, the processing terminal 160, the data monitoring module 123, etc.) of the damping test system 100 for the wood-based material based on full sampling of the free vibration curve.

In some embodiments of the present disclosure, the damping test system for the wood-based material based on full sampling of the free vibration curve controls the operation of at least one of the force application module, the data monitoring module, the environment control device, or the like, by determining the test scheme, so that the carrying space can be maintained in the appropriate vibration condition and environment, thereby improving the accuracy of the obtained damping ratio and the logarithmic attenuation value.

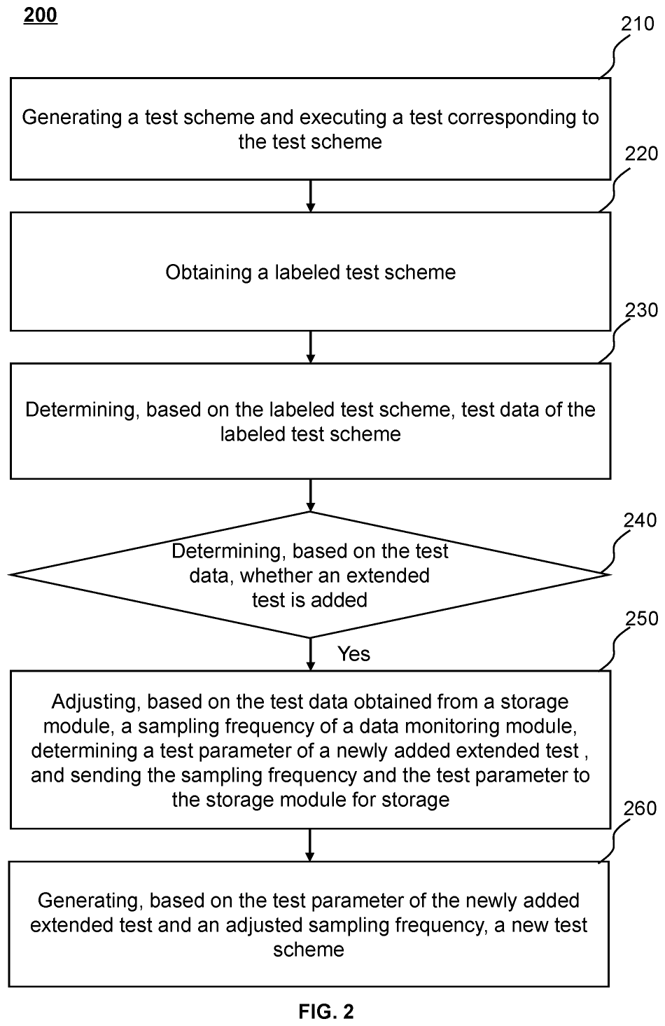

FIG. 2 is flowchart illustrating an exemplary damping test method for a wood-based material based on full sampling of a free vibration curve according to some embodiments of the present disclosure. In some embodiments, a process 200 may be implemented by a processor of a damping test system for a wood-based material based on full sampling of a free vibration curve. As illustrated in FIG. 2, the process 200 may include the following operations.

In 210, a test scheme may be generated and a test corresponding to the test scheme may be executed.

A test scheme refers to means of performing a damping test on the wood-based material. For example, the test scheme may include a sampling frequency, a test duration, a wood-based material feature, and a test parameter during the damping test.

The sampling frequency is a number of times the data monitoring module samples data over a period of time (e.g., within a predetermined period). The predetermined period may be any positive number, such as 1 s, 10 s, 100 s, or the like. For example, if the sampling frequency of the data monitoring module is 60 times/s, the data monitoring module may collect data 60 times per second.

A test duration refers to the duration of performing the test scheme.

In some embodiments, different wood-based materials may correspond to different test schemes.

A wood-based material feature refers to data related to the wood-based material. For example, the material feature may include a material type, thermal properties, mechanical properties, or the like, of the wood-based material. The thermal properties may include a thermal conductivity, or the like. The mechanical properties may include a degree of impact resistance, or the like. In some embodiments, the material feature may be represented as a vector (A1, A2, A3, . . . ). A1, A2, and A3 may represent the material type, the thermal properties, the mechanical properties, or the like, of the wood-based material, respectively.

A test parameter refers to a parameter used during the damping test. For example, the test parameter may include a material parameter of a model hardware, a disturbance parameter of a force application module, and an environmental regulation parameter.

A material parameter of a model hardware refers to data related to the model hardware. The model hardware may include a spring, a damper, or the like. In some embodiments, the material parameter of the model hardware may include an elastic coefficient of the spring and a damping coefficient of the damper, etc.

A disturbance parameter refers to a parameter related to an external excitation applied by the force application module. For example, the disturbance parameter may include a type of excitation, a size of the excitation, or the like. The type of excitation may include at least one of a force, a speed, a displacement, or the like, applied to the wood-based material.

An environmental regulation parameter refers to a parameter related to an environment in which the damping test is conducted. In some embodiments, the environmental regulation parameter refers to a parameter used by an environmental regulation device for regulating an internal environment of a carrying space. The environmental regulation parameter may include a temperature, a humidity, a vacuum degree, or the like. For example, the environmental regulation device may control the internal environment of the carrying space at a predetermined temperature, humidity, vacuum degree, or the like, based on the environmental regulation parameter.

In some embodiments, a test may include an initial test and/or an extended test.

An initial test refers to a first set damping test. An extended test refers to a damping test executed after the initial test.

In some embodiments, at least one of a sampling frequency, a test duration, and a test parameter of the extended test may be different from those of the initial test. For example, the vacuum level of the extended test may be different from the vacuum level of the initial test. As another example, the sampling frequency of the extended test may be different from the sampling frequency of the initial test.

In some embodiments, different test schemes may correspond to different test types and numbers. For example, the test scheme may be an initial test scheme which is performed one time as the initial test on the wood-based material. The test scheme may also be an extended test scheme which is performed one time as the extended test on the wood-based material. The test scheme may also be a chronological initial test and one or more extended tests, of which each test is performed one or more times sequentially as the initial test and one or more extended tests on the wood-based material. A test type may be at least one of the initial test or the extended test.

In some embodiments, the processor may determine the test scheme in various ways. For example, the processor may obtain the test scheme based on a production schedule. As another example, the processor may obtain the test scheme through manual input or a storage module.

In some embodiments, the processor may determine the test scheme based on a test demand (e.g., the wood-based material feature, the material parameter of the model hardware, etc.). For example, the processor may determine a predetermined table of various test demands and control instructions corresponding to the various test demands based on historical production experience, and determine the control instructions by looking up the table.

In some embodiments, the processor may send the disturbance parameter, the sampling frequency, the environmental regulation parameter, or the like, of the test scheme to a corresponding device (e.g., the force application module, the data monitoring module, the environmental regulation device) to control the operation of the corresponding device.

In 220, a labeled test scheme may be obtained.

In some embodiments, a labeled test scheme indicates that the test corresponding to the test scheme is executed completely.

In some embodiments, the processor may obtain the labeled test scheme based on a user operation. For example, the user operation may include various ways such as manual operation, input control, or the like. In some embodiments, the user may label a completely executed program in various forms, such as an Arabic numeral, an English letter, a representative character (e.g., an English initial), or a personalized setting of the user, which are not limited in the present disclosure.

In 230, test data of the labeled test scheme may be determined based on the labeled test scheme.

Test data refers to data related to the damping test. In some embodiments, the test data may include a displacement and an acceleration of the wood-based material during the damping test. In some embodiments, the test data may further include data obtained by calculation after the completion of the damping test. For example, the test data may include an intrinsic frequency, a damping ratio, or the like, of the wood-based material during a free vibration process.

In some embodiments, the test data may include at least a logarithmic attenuation value of the labeled test scheme.

A logarithmic attenuation value refers to a parameter for characterizing free vibration properties of the wood-based material.

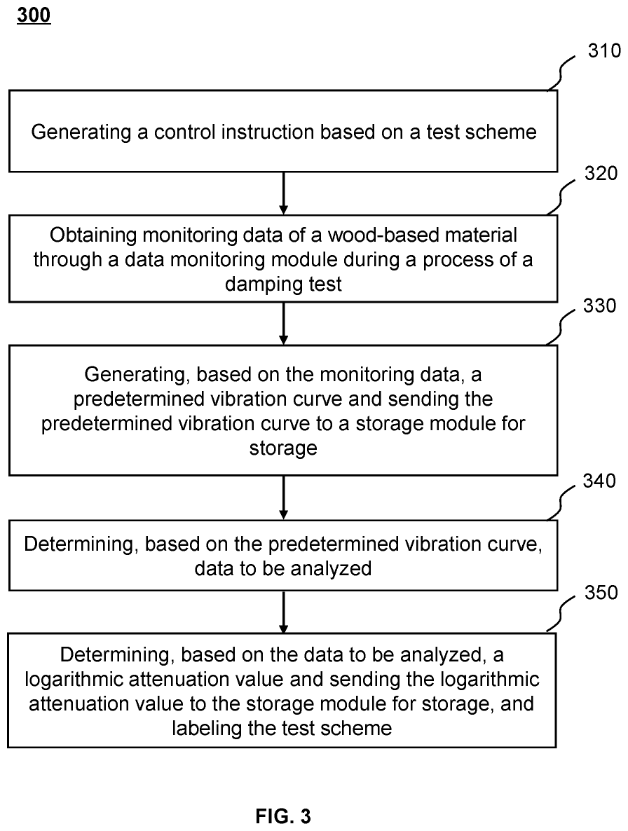

In some embodiments, the processor may determine the test data in various ways. For example, during a test execution process of each test scheme, the processor may obtain the displacement or the acceleration of the wood-based material during the free vibration process through the data monitoring module. As another example, after the test corresponding to the test scheme is executed completely, the processor may obtain a predetermined vibration curve by analyzing and processing the obtained displacement or the acceleration. The processor may determine the logarithmic attenuation value based on a ratio of two peak amplitudes of the predetermined vibration curve. As another example, the processor may calculate the damping ratio based on the obtained displacement or the acceleration by a half-power bandwidth method, a time-domain attenuation method, or the like. More descriptions regarding the predetermined vibration curve may be found in FIG. 3 and the related descriptions thereof.

A peak amplitude refers to a value corresponding to a highest point of the curve over a period of time. The two peak amplitudes may be two consecutive adjacent peak amplitudes or peak amplitudes spaced apart by a predetermined number of vibration periods. More descriptions regarding the predetermined vibration curve may be found in FIG. 3 and the related descriptions thereof. A vibration period refers to a time interval between two adjacent peak amplitudes.

In some embodiments, the processor may send the test data to the storage module for storage.

For example, a process of calculating the logarithmic attenuation value may be described below.

In some embodiments, the processor may establish a kinetic equation based on a free vibration of the wood-based material due to an initial disturbance. The kinetic equations may be represented by equations (1), (2), and (3):

$$\ddot{x} + 2 ζ {\overline{ω}}_{n} \dot{x} + {\overline{ω}}_{n}^{2} x = 0 ; \qquad ( 1 )$$

$${\overline{ω}}_{n} = {( k / m )}^{1 / 2} ; \qquad ( 2 )$$

$$ζ = c / 2 m {\overline{ω}}_{n} = c / 2 \sqrt{m k} ; \qquad ( 3 )$$

Wherein c denotes the damping coefficient, k denotes the elastic coefficient, ω̅ₙ denotes the intrinsic frequency, ζ denotes the damping ratio, m denotes a mass of the wood-based material, x denotes a movement distance of the wood-based material during the free vibration process, \dot{x} denotes a speed of the wood-based material during the free vibration process, and \ddot{x} denotes the acceleration of the wood-based material during the free vibration process.

The intrinsic frequency and the damping ratio refer to parameters exhibited by the wood-based material during the free vibration process without the external excitation. The intrinsic frequency and the damping ratio are inherent properties of the single degree of freedom system determined by the mass, the elastic coefficient, the damping coefficient, and other intrinsic factors of the wood-based material.

In some embodiments, for wood and other viscoelastic materials, ζ<1, i.e., c²<4 mk, the processor may solve the equation (1) using the solution of the quadratic equation to obtain equations (4), (5), (6), and (7):

$$x ( t ) = A {e}^{- ζ {\overline{ω}}_{n} i} cos ( {\overline{ω}}_{d} t - θ ) ; \qquad ( 4 )$$

$${\overline{ω}}_{d} = {{\overline{ω}}_{n} ( 1 - {ζ}^{2} )}^{1 / 2} ; \qquad ( 5 )$$

$$A = \sqrt{{x}_{0}^{2} + {( \frac{{x}_{0} ζ {\overline{ω}}_{n} + {\dot{x}}_{0}}{{\overline{ω}}_{d}} )}^{2}} ; \qquad ( 6 )$$

$$cos θ = {x}_{0} / A ; \qquad ( 7 )$$

Wherein x₀ and \dot{x}₀ denote an initial position and an initial speed of the wood-based material at t=0, ω̅_{d} denotes a damping vibration frequency of the free vibration, A denotes the peak amplitude of the free vibration, θ denotes an initial phase of the free vibration, and x(t) represents a time function for the movement distance of the wood-based material during the free vibration process.

In some embodiments, the processor may determine the logarithmic attenuation value based on the following equation (8):

$$δ = \frac{1}{n} ln \frac{{A}_{1}}{{A}_{n + 1}} ; \qquad ( 8 )$$

Wherein δ denotes the logarithmic attenuation value, A₁ and Aₙ₊₁ denote two peak amplitudes spaced apart by n oscillation periods T on the predetermined vibration curve, and n is a predetermined value.

In some embodiments, when the logarithmic attenuation value is represented as the natural logarithm of the ratio of the two adjacent peak amplitudes, the processor may determine a relationship between the damping ratio and the logarithmic attenuation value based on equation (9), and then establish the damping ratio of the wood-based material:

$$δ = ln ( {e}^{ζ {\overline{ω}}_{n} T} ) = \frac{2 πζ}{{( 1 - {ζ}^{2} )}^{1 / 2}} ; \qquad ( 9 )$$

$$T = \frac{2 π}{{\overline{ω}}_{d}} ; \qquad ( 10 )$$

Wherein the letters in the equation may be found in the relevant description above.

In some embodiments, the processor may generate, based on the monitoring data, the predetermined vibration curve; determine, based on the predetermined vibration curve, data to be analyzed; and determine, based on the data to be analyzed, the logarithmic attenuation value. More descriptions may be found in FIG. 3 and the related descriptions thereof.

In 240, whether an extended test is added may be determined based on the test data.

In some embodiments, the processor may perform a test based on a reference wood-based material and a current test scheme, calculate an error between a damping ratio of the current test scheme and a reference damping ratio based on the test data, and determine whether the error is greater than an error threshold. In response to determining that the error is greater than the error threshold, it is determined to add the extended test. The error refers to a difference between the damping ratio of the current test scheme and the reference damping ratio. The current test scheme refers to a test scheme corresponding to a most recent executed test. The error threshold may be a system predetermined value, a system default value, etc. In some embodiments, the reference damping ratio of the reference wood-based material may be a predetermined value. The processor may further determine the reference damping ratio of the reference wood-based material by manual input.

In some embodiments, the processor may determine, based on the test data, whether the extended test is added after each labeled test scheme is obtained.

In 250, in response to determining that the extended test is added, a sampling frequency of the data monitoring module may be adjusted, a test parameter of a newly added extended test may be determined, and the sampling frequency and the test parameter may be sent to the storage module for storage based on the test data obtained from the storage module.

A newly added extended test refers to an added extended test.

In some embodiments, the test parameter of the newly added extended test may include at least one of the material parameter of the model hardware and the disturbance parameter of the force application module. The material parameter of the model hardware may include at least one of the elastic coefficient of the spring and the damping coefficient of the damper.

More descriptions regarding the sampling frequency, the material parameter of the model hardware, the disturbance parameter of the force application module, etc., may be found in FIG. 2 and the relevant descriptions thereof.

In some embodiments, the processor may adjust the sampling frequency of the data monitoring module based on an adjustment manner. The adjustment manner may include a magnitude adjustment and a direction adjustment, etc. A magnitude adjustment refers to adjusting a magnitude of the sampling frequency. A direction adjustment may be configured to determine a direction of the adjustment, such as to increase or decrease the sampling frequency of the data monitoring module.

In some embodiments, the adjustment manner of the sampling frequency of the data monitoring module may be determined based on the logarithmic attenuation value. For example, the processor may statistically analyze the logarithmic attenuation values of all the labeled test schemes to calculate a variance of the logarithmic attenuation values. When the variance is greater than a predetermined threshold, the direction adjustment may include increasing the sampling frequency. When the variance is not greater than the predetermined threshold, the direction adjustment may include decreasing the sampling frequency. The magnitude adjustment may be determined based on correspondences between different variances and different magnitude adjustments. The predetermined threshold may be a value determined based on experimentation or experience.

In some embodiments, the adjustment may be made for the sampling frequency in the current test scheme or for the sampling frequency in a test scheme corresponding to the initial test.

In some embodiments, in response to determining that a data volume of the data to be analyzed satisfies a second predetermined condition, the processor may, based on the data volume of the data to be analyzed and the sampling frequency of the labeled test scheme, adjust the sampling frequency of the newly added extended test and send the sampling frequency of the newly added extended test to the data monitoring module and/or upload the sampling frequency of the newly added extended test to the storage module.

More descriptions regarding the data to be analyzed may be found in FIG. 3 and the relevant descriptions thereof.

The data volume of the data to be analyzed refers to a count of sampling points within a predetermined time range. In some embodiments, the processor may statistically analyze the sampling points within the predetermined time range to determine the data volume of the data to be analyzed.

A second predetermined condition refers to a determination condition for evaluating whether to adjust the sampling frequency. For example, the second predetermined condition may include that the data volume of the data to be analyzed is less than a volume threshold. The volume threshold may be a system default value, a system predetermined value, etc.

In some embodiments, the data volume of the data to be analyzed refers to a data volume to be included in the data to be analyzed to record a vibration state of the wood-based material.

In some embodiments, the processor may adjust the sampling frequency based on the volume threshold and the data volume of the data to be analyzed. For example, an adjusted sampling frequency may be positively correlated with a ratio of the volume threshold to the data volume of the data to be analyzed. As another example, the adjusted sampling frequency=K1*current sampling frequency*volume threshold/data volume of the data to be analyzed. The current sampling frequency refers to a sampling frequency in the current test scheme. K1 is a predetermined value.

In some embodiments of the present disclosure, by determining the data volume to be analyzed, the sampling frequency may be increased to enhance the data volume to be analyzed, thereby improving the accuracy of the calculated logarithmic attenuation value, and avoiding incidental errors in the analysis results.

In some embodiments, the processor may determine the test parameter of the newly added extended test based on the test data in various ways. For example, the processor may obtain a manually input test parameter of the newly added extended test through an interaction module. As another example, the processor may obtain the test parameter in the labeled test scheme from the storage module as the test parameter of the newly added extended test. As another example, the processor may read through an interface of the processing terminal. The interface may include but not limited to a program interface, a data interface, a transmission interface, or the like. In some embodiments, when it is determined that the extended test needs to be added, the system may automatically extract the test parameter of the newly added extended test from the interface.

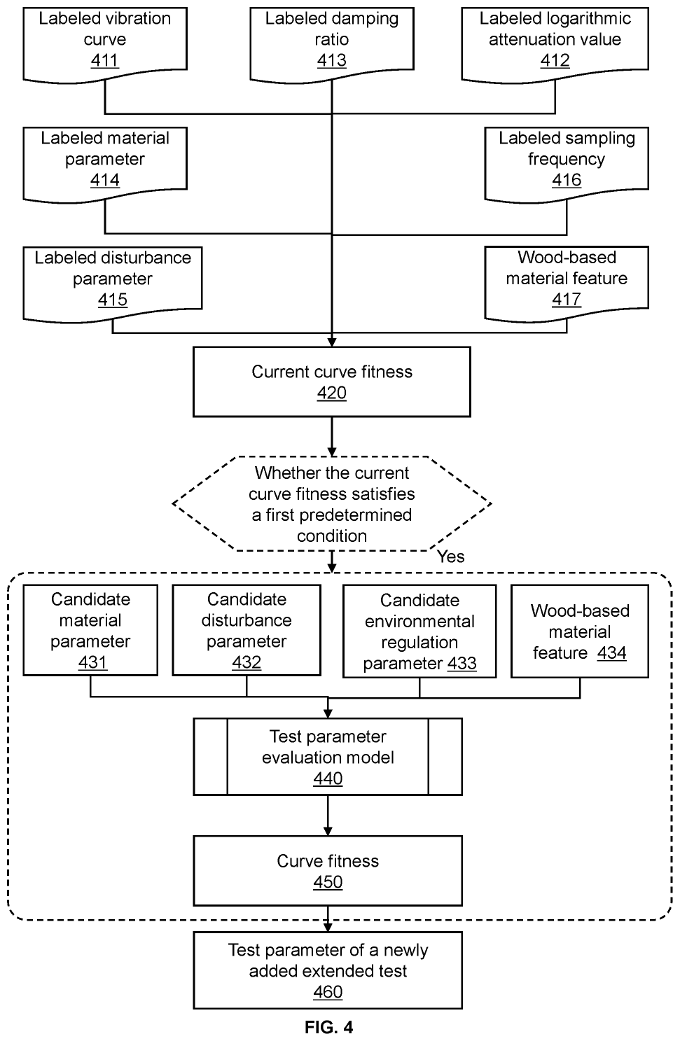

In some embodiments, the processor may determine the test parameter of the newly added extended test based on a labeled vibration curve, a labeled logarithmic attenuation value, a labeled damping ratio, a labeled material parameter, a labeled disturbance parameter, a labeled sampling frequency, and a wood-based material feature. More descriptions may be found in FIG. 4 and the relevant descriptions thereof.

In 260, a new test scheme may be generated based on the test parameter of the newly added extended test and the adjusted sampling frequency.

A new test scheme refers to a test scheme corresponding to the newly added extended test. The new test scheme may be used for performing the damping test on the wood-based material.

In some embodiments, the processor may form the new test scheme based on the test parameter of the newly added extended test and the adjusted sampling frequency, and upload the new test scheme to the storage module.

In some embodiments, the processor may perform the damping test on the wood-based material based on the new test scheme at a predetermined time. The predetermined time may be any time after the current test scheme. For example, the predetermined time may be a same time point as the test corresponding to the current test scheme is completed, or a time point after a specific time interval.

The predetermined time is a start time to begin performing the test corresponding to the new test scheme.

It should be noted that in an actual test, insufficient disturbance parameter of the force application module may occur, leading to data not being close enough to the actual situation, and the material parameter of the model hardware may not be suitable for measuring the current wood-based material, and disturbances in the environment such as wind may occur, increasing the error in the calculated damping ratio. By determining whether the newly added extended test is added, the frequency of the environment, the model hardware, and the data monitoring module may be controlled to reduce the error caused by empirically determining impedance properties, thereby making the test results closer to the actual situation.

In some embodiments of the present disclosure, by determining whether the newly added extended test is added, a reasonable number of tests may be determined, so that the reliability and accuracy of the determined logarithmic attenuation value may be creased, the influence of accidental errors may be reduced, and the impact of a single factor on the test data may be avoided. In addition, more data points may be provided, thereby further accurately reproducing the free vibration process of the wood-based material. The damping properties may be measured by calculating the logarithmic attenuation value, and the damping properties of the structural material may be determined without setting initial conditions, so that the damping test system and the damping test method are of practical value and conducive to measurement of the damping properties of the wood-based material.

FIG. 3 is a flowchart illustrating an exemplary process of determining a logarithmic attenuation value according to some embodiments of the present disclosure. In some embodiments, a process 300 may be implemented by a processor of a damping test system for a wood-based material based on full sampling of a free vibration curve. As illustrated in FIG. 3, the process 300 may include the following operations.

In 310, a control instruction may be generated based on a test scheme.

A control instruction refers to an instruction used to control a damping test device to perform a damping test.

In some embodiments, the control instruction may include an instruction for controlling operation of a force application module, a data monitoring module, an environmental regulation device, etc. In some embodiments, the control instruction may include one or more instructions, such as a sampling instruction corresponding to a sampling frequency of the data monitoring module, or the like; and a test instruction corresponding to a test parameter of the force application module and a test parameter of the environmental regulation device.

More descriptions regarding the force application module, the data monitoring module, and the environmental regulation device may be found in FIG. 1 and the related descriptions of thereof.

More descriptions regarding the test parameter and the sampling frequency may be found in FIG. 2 and the related descriptions thereof.

In some embodiments, the processor may send the control instruction to a corresponding device (e.g., the force application module, the data monitoring module, the environmental regulation device, etc.) to control the operation of the corresponding device.

For example, the processor may send the sampling command to the data monitoring module to control the data monitoring module to sample a vibration state (e.g., a displacement and acceleration). As another example, the processor may send the test instruction to the force application module and the environmental regulation module to apply an external excitation to the wood-based material and to adjust an internal environment of carrying space, etc.

A damping test refers to an experiment used to measure damping properties of a material or structure by applying an external excitation of a certain frequency and amplitude to cause a free vibration of the material or structure.

In some embodiments, the processor may determine the control instruction based on the test scheme (e.g., a wood-based material feature, a material parameter of a model hardware, etc.). For example, the processor may determine a predetermined table of different test schemes and control instructions corresponding to different test schemes based on historical production experience, and determine a current control instruction by looking up the table.

In some embodiments, the processor may, based on the test scheme, generate the control instruction to control the operation of at least one of the force application module, the data monitoring module, the environmental regulation device, or the like, to perform the damping test on the wood-based material.

In 320, monitoring data of the wood-based material may be obtained through the data monitoring module during a process of the damping test.

Monitoring data refers to data used to reflect the vibration state of the wood-based material. For example, the monitoring data may include a displacement, a speed, or the like, of the wood-based material.

In some embodiments, the data monitoring module may sample the vibration state of the wood-based material based on the sampling frequency to obtain the monitoring data.

In some embodiments, the monitoring data may be collected by the data monitoring module and uploaded to the processor on a periodic or real-time basis. In some embodiments, the monitoring data may be collected by the data monitoring module and uploaded in real time to the storage module for storage. The processor may read the monitoring data from the storage module on a periodic or real-time basis.

In 330, a predetermined vibration curve may be generated based on the monitoring data, and the predetermined vibration curve may be sent to a storage module for storage.

The predetermined vibration curve is used to describe a relationship between a movement distance of the wood-based material in the free vibration process along a vibration direction (e.g., a vertical direction or a horizontal direction) and time.

In some embodiments, the predetermined vibration curve may be a curve fitted from a plurality of discrete sampling points. More descriptions regarding the sampling points may be found in FIG. 1 and the relevant descriptions thereof.

In some embodiments, the predetermined vibration curve may be obtained based on sampling of the free vibration of the wood-based material by the data monitoring module. The processor may control the force application module to apply an initial disturbance in a specified direction (e.g., the vertical direction or the horizontal direction) to the wood-based material to cause the free vibration of the wood-based material. For example, the processor may control the force application module to apply the initial disturbance in the vertical direction to the wood-based material to cause the free vibration of the wood-based material in the vertical direction. The processor may control the data monitoring module to sample a displacement of the wood-based material in the vertical direction based on the sampling frequency.

In some embodiments, the processor may determine the predetermined vibration curve by fitting displacements corresponding to individual times through a fitting algorithm. The fitting algorithm may include a least squares method, a Levenberg-Marquardt algorithm, genetic algorithm, etc.

In some embodiments, the specified direction may include one of the vertical direction, the horizontal direction, or the like.

The initial disturbance is an external excitation applied to the wood-based material to cause the wood-based material to deviate from an equilibrium position. In some embodiments, the initial disturbance may be a force that changes abruptly in time, with a value of the force suddenly jumping from zero to a constant value at a certain time point, and then reverting to zero after remaining constant for a predetermined time period. The predetermined time period may be determined based on experimentation or experience. For example, the predetermined time period may be 1 second, 5 seconds, etc.

The free vibration refers to an oscillatory movement of the wood-based material that occurs without the external disturbance, during which the wood-based material deviates from the equilibrium position under the influence of initial disturbance, and then returns to the equilibrium position due to a viscoelastic force, and so on repeatedly.

Sampling refers to a process in which the data monitoring module collects the vibration state of the wood-based material based on the sampling frequency.

In some embodiments, the processor may, based on the acceleration, perform fitting to obtain the predetermined vibration curve.

The acceleration is a physical quantity that describes how quickly or slowly the wood-based material changes speed during the free vibration.

In some embodiments, the processor may determine, based on an initial speed and the acceleration of the wood-based material, the displacement of the wood-based material at various times through a physical relationship between the acceleration and the displacement, and perform, based on the fitting algorithm similar to that described above, fitting on the displacements corresponding to the various times to determine the predetermined vibration curve.

In some embodiments of the present disclosure, a resolution and a

measurement accuracy of the accelerometer may be high, which allows for accurate measurement of small displacement changes, thereby improving the accuracy and the reliability of the determined predetermined vibration curve.

In 340, data to be analyzed may be determined based on the predetermined vibration curve.

Data to be analyzed refers to a portion of data on the predetermined vibration curve.

In some embodiments, the processor may determine the data to be analyzed based on the predetermined vibration curve in various ways. For example, the processor may obtain the data to be analyzed based on the predetermined vibration curve by random interception. As another example, the processor may intercept sampling points within a predetermined time range to be determined as the data to be analyzed. The predetermined time range may be a system predetermined value, a system default value, etc. The predetermined time range may also be a value determined based on experimentation or experience.

In some embodiments, the data to be analyzed may be data intercepted at sampling points located between T₁ and T₂, wherein T₁=0.018 s, and T₂=0.028 s.

It should be noted that when the damping properties are measured using a conventional method, due to the higher damping of the wood-based material, most of energy is consumed, resulting in fewer free oscillations, faster amplitude attenuation, and poorer quality of the free vibration curve. As a result, fewer peak points may be selected for calculating the logarithmic attenuation value, leading to a larger coefficient of variation and lower accuracy of the calculated logarithmic attenuation value. Therefore, by selecting all sample points within the predetermined time range, the damping properties of the wood-based material may be more comprehensively reflected, thereby avoiding accidental errors.

In some embodiments of the present disclosure, the monitoring data before T₁ is susceptible to transient shock from the initial disturbance and the higher resonance signal, while the data after T₂ is susceptible to circuit noise (with a relatively low signal-to-noise ratio), resulting in relatively poor quality of the sampling points. By using the specified predetermined time range, high-quality data to be analyzed may be obtained, facilitating the processor in quickly obtaining the data to be analyzed, and improving calculation efficiency.

In 350, the logarithmic attenuation value may be determined based on the data to be analyzed and the logarithmic attenuation value may be sent to the storage module for storage, and a test scheme may be labeled.

In some embodiments, the processor may select two peak amplitudes from the data to be analyzed based on the data to be analyzed and determine the logarithmic attenuation value through an equation (8).

In some embodiments, the processor may label the test scheme in a manner similar to that in FIG. 2.

In some embodiments, the processor may send the logarithmic attenuation value to the storage module for storage.

In some embodiments, the processor may also perform fitting based on the data to be analyzed to obtain a spiral curve.

The spiral curve is used to characterize a free vibration process of the wood-based material in a phase plane.

In some embodiments, the processor may obtain data to be analyzed by intercepting data within the predetermined time range based on the predetermined vibration curve of the wood-based material; and determine the spiral curve by a rotation vector method based on the data to be analyzed.

A rotation vector method refers to a method of characterizing the free vibration as a projection of a uniformly rotating vector on a coordinate axis. For example, in planar polar coordinates, a length of the vector is represented as an amplitude; a magnitude of a rotational angular speed of the vector is represented as a damped vibration frequency of the free vibration; an angle between the vector and the coordinate axis at an arbitrary time is represented as a phase of the free vibration; and a projection of the vector on the coordinate axis is represented as the displacement of the free vibration.

In some embodiments, the processor may establish a coordinate system based on the x(t) and

$$\frac{x \dot{(} t )}{{\overline{ω}}_{d}}$$

to describe the free vibration of the wood-based material. For example, the processor may plot the spiral curve based on the data to be analyzed by using available software (e.g., MATLAB, etc.) with a horizontal axis representing x(t) and a vertical axis representing

$$\frac{\dot{x ( t )}}{{ϖ}_{d}} .$$

In some embodiments, a radius R of the spiral curve may be determined based on an equation (11):

$$R = \sqrt{{x ( t )}^{2} + {( \frac{\dot{x ( t )}}{{ϖ}_{d}} )}^{2}} ; \qquad ( 11 )$$

The equation (4) and the equation (5) may be substituted into the equation (11) to obtain an equation (12):

$$R = {{Ae}^{- {ζϖ}_{n} i} [ 1 + {ζ}^{2} {cos}^{2} ( {ϖ}_{d} t - θ ) + ζ \sqrt{1 - {ζ}^{2}} sin ( 2 {ϖ}_{d} t - 2 θ ) ]}^{1 / 2} ; \qquad ( 12 )$$

In some embodiments, the wood-based material may be wood and other viscoelastic materials. Usually, the damping ratio ζ of the wood-based material may be less than 0.02, and then the equation (12) may be expressed as an equation (13). It is experimentally verified that an error between the equation (12) and the equation (13) may not exceed 1%:

$$R = {Ae}^{- {ζϖ}_{n} i} ; \qquad ( 13 )$$

In some embodiments, the processor may calculate a natural logarithm of the equation (13) to obtain an equation (14):

$$ln R = ln A - {ζϖ}_{n} t ; \qquad ( 14 )$$

In some embodiments, the processor may perform a linear regression analysis of the equation (14) to determine a slope of the equation (14) and calculate the damping ratio ζ.

It should be noted that in the conventional method: the damping ratio may be measured by a four-parameter simplex method based on all the sample points in the free vibration curve, which maximizes the use of the data from the sampling points, however, the method may rely on the setting of initial conditions before analyzing the data. When the initial conditions are set too much, temporary loops or dead loops may occur. The time-domain attenuation method only analyzes the free attenuation vibration waveforms at a single frequency, while not applicable to the complex frequency components. The signal of the half-power bandwidth method analyzes the damping properties only in the frequency domain, and fails to capture the features in the time domain, which is liable to be affected by the interference of the noise and the distortion of the signal, and the accuracy and the reliability may fluctuate greatly in practical applications.

In some embodiments of the present disclosure, the radius R of the spiral curve may be determined by all the sample points of the free vibration curve, and then a linear expression of the natural logarithm of the radius and the damping ratio may be determined. The slope of the linear expression may be determined by performing the linear regression analysis of the linear expression, and then the damping ratio ζ may be calculated, thereby making the calculated damping ratio more accurate and reliable.

The coefficient of variation may be used to measure a degree of variability of the data. In some embodiments, the processor may determine the coefficient of variation based on a ratio of a standard deviation and a mean of the damping ratios in a plurality of tests.

In some embodiments of the present disclosure, by selecting all the sample points to determine the spiral curve, and analyzing the expression of linear regression, the damping properties of the wood-based material may be more comprehensively reflected, and errors that may result from the calculation method based only on the two peak amplitudes may be avoided.

In some embodiments of the present disclosure, by monitoring the damped vibration of the wood-based material, a large number of sampling points may be obtained, and a high-quality predetermined vibration curve may be obtained, which helps to determine an appropriate and accurate spiral curve in the future, thereby improving the accuracy of the determined damping ratio.

It should be noted that the foregoing descriptions of the processes 200 and 300 are for exemplification and illustration purposes only, and do not limit the scope of application of the present disclosure. For a person skilled in the art, various corrections and changes may be made to the processes 200 and 300 under the guidance of the present disclosure. However, these corrections and changes remain within the scope of the present disclosure.

FIG. 4 is a schematic diagram illustrating an exemplary process of determining a test parameter of a newly added extended test according to some embodiments of the present disclosure.

In some embodiments, as illustrated in FIG. 4, for at least one labeled test scheme, a processor may determine, based on a labeled vibration curve 411, a labeled logarithmic attenuation value 412, a labeled damping ratio 413, a labeled material parameter 414, a labeled disturbance parameter 415, and a labeled sampling frequency 416 obtained from a storage module, and a wood-based material feature 417, a test parameter 460 of the newly added extended test; and send the test parameter 460 of the newly added extended test to at least one of an interaction module, a force application module, and an environmental regulation device.

A labeled vibration curve, a labeled logarithmic attenuation value, a labeled damping ratio, a labeled material parameter, a labeled disturbance parameter, and a labeled sampling frequency refer to a predetermined vibration curve, a logarithmic attenuation value, a damping ratio, a material parameter, a disturbance parameter, and a sampling frequency corresponding to the labeled test scheme.

In some embodiments, the labeled test scheme refers to a test scheme completed in a previous test, or all test schemes completed for the wood-based material from a startup of a system to a current time. Each the labeled test scheme may correspond to at least one labeled vibration curve, one labeled logarithmic attenuation value, one labeled damping ratio, one labeled material parameter, one labeled disturbance parameter, one labeled sampling frequency (hereinafter referred to as a labeled parameter set), etc.

More descriptions regarding the predetermined vibration curve, the logarithmic attenuation value, the damping ratio, the material parameter, the disturbance parameter, the sampling frequency, and the environmental regulation parameter may be found in the relevant descriptions of FIG. 2.

In some embodiments, the processor may determine the test parameter of the newly added extended test based on the labeled parameter set and the wood-based material feature in various ways. For example, the processor may determine the test parameter of the newly added extended test based on the wood-based material features and at least one labeled parameter set through various methods such as vector matching, software simulation, or the like.

In some embodiments, as illustrated in FIG. 4, the processor may determine, based on the labeled vibration curve 411, the labeled logarithmic attenuation value 412, the labeled damping ratio 413, the labeled material parameter 414, the labeled disturbance parameter 415, the labeled sampling frequency 416, and the wood-based material feature 417, a current curve fitness 420; and determine, based on the current curve fitness 420, the test parameter 460 of the newly added extended test.

The current curve fitness refers to a curve fitness of a test scheme that is executed completely prior to a current time for a given wood-based material. Curve fitness is a measure of whether a curve (e.g., the predetermined vibration curve and the spiral curve) satisfies the requirements. For example, the curve fitness may reflect whether the curve is normal (e.g., whether a shape, a trend, and a variation of the curve are as expected), and whether a granularity of the curve is too large (e.g., whether a count of sampling points is appropriate). Current time is a time at which the test parameter of the newly added extended test needs to be determined.

In some embodiments, the processor may generate, based on the labeled material parameter, the labeled disturbance parameter, the labeled sampling frequency, and the wood-based material feature of the at least one labeled test scheme, a retrieval vector, perform, based on the retrieval vector, a search in a database to determine a reference vector that satisfies a matching condition as a target vector, and obtain a standard vibration curve, a standard logarithmic attenuation value, and a standard damping ratio corresponding to the target vector.

A matching condition refers to a determination condition used to determine the target vector. The matching condition may include that a vector distance from the retrieval vector is less than a distance threshold, or the vector distance is minimal, etc. The vector distance may be calculated in various ways, such as a Euclidean distance, a cosine distance, etc.

A database refers to a database used for storing, indexing, and querying vectors. The database may store a plurality of reference vectors and the standard vibration curve, the standard logarithmic attenuation value, and the standard damping ratio corresponding to each of the plurality of reference vectors.

In some embodiments, the database may be constructed based on a large amount of experimental data. For example, repeated damping tests may be performed on a reference wood-based material with a reference damping ratio for multiple times based on different test schemes to obtain a large amount of experimental data; fitting may be performed based on the experimental data to obtain a corresponding experimental vibration curve; an experimental damping ratio may be determined based on the experimental vibration curve in a way similar to that of determining the spiral curve, and a material parameter, a disturbance parameter, a sampling frequency, and a wood-based material feature whose errors between the experimental damping ratio and the reference damping ratio are within a predetermined range may be determined as reference vectors, an experimental vibration curve corresponding to the reference vectors may be determined as the standard vibration curve, an experimental logarithmic attenuation value corresponding to the reference vectors may be determined as the standard logarithmic attenuation value, and the experimental damping ratio may be determined as the standard damping ratio.

In some embodiments, the processor may calculate, based on the labeled vibration curve and the standard vibration curve, a curve similarity. The curve similarity may include a Pearson correlation coefficient, a Euclidean distance, etc. When a plurality of labeled test schemes are provided or a plurality of tests corresponding to the plurality of labeled test schemes are provided, a plurality of predetermined vibration curves may be obtained. Accordingly, a plurality of curve similarities may be calculated. The processor may determine a final curve similarity based on a mean of the plurality of curve similarities.

Experimental data refers to test data obtained through experimentation. The experimental vibration curve refers to a predetermined vibration curve obtained by fitting experimental monitoring data. The experimental damping ratio refers to a damping ratio obtained by calculating the experimental vibration curve. The experimental logarithmic attenuation value refers to a logarithmic attenuation value calculated by the experimental vibration curve.

In some embodiments, the processor may calculate, based on the labeled logarithmic attenuation value and the standard logarithmic attenuation value, an error between the labeled logarithmic attenuation value and the standard logarithmic attenuation value to be determined as a first similarity; and calculate, based on the labeled damping ratio and the standard damping ratio, an error between the labeled damping ratio and the standard damping ratio to be determined as a second similarity.

When the plurality of labeled test schemes are provided or the plurality of tests corresponding to the plurality of labeled test schemes are provided, a plurality of logarithmic attenuation values and damping ratios may be obtained. Accordingly, a plurality of first similarities and second similarities may be calculated. The processor may determine a final first similarity based on a mean of the plurality of first similarities, determine a final second similarity based on a mean of the plurality of second similarities, and obtain a numerical similarity based on the final first similarity and the final second similarity. The numerical similarity may be one of the plurality of first similarities, the plurality of second similarities, mean of the plurality of first similarities, or the mean of the plurality of second similarities, or the like.

In some embodiments, the processor may determine the current curve fitness based on the final curve similarity and the numerical similarity. For example, the processor may determine the current curve fitness by summing a product of the final curve similarity and a first coefficient and a product of the numerical similarity and a second coefficient.

In some embodiments, the first coefficient and the second coefficient may be parameters that cause the above summation to reach a same dimension. For example, if a of the final curve similarity is meter, and the numerical similarity is a dimensionless value, the first coefficient may be a value that causes the final curve similarity to be dimensionless.

In some embodiments, the first coefficient and the second coefficient may be weights that cause the above summation to reach the same dimension. Magnitudes of the first coefficient and the second coefficient may be determined based on experimentation or experience.

In some embodiments, a test parameter evaluation model may be a model configured to determine the curve fitness. More descriptions may be found in FIG. 4 and the relevant descriptions thereof.

In some embodiments, the processor may select, based on the current curve fitness, a same or similar historical curve fitness from historical data, and determine a recommended test parameter of a historical newly added extended test corresponding to the historical curve fitness as a current recommended test parameter of the newly added extended test. A historical curve fitness refers to a curve fitness corresponding to a test scheme that is executed completely prior to the historical newly added extended test.

In some embodiments, as illustrated in FIG. 4, in response to determining that the current curve fitness satisfying a first predetermined condition, the processor may determine, based on a candidate material parameter 431, a candidate disturbance parameter 432, a candidate environmental regulation parameter 433, and a wood-based material feature 434, the recommended test parameters of the newly added extended test through a test parameter evaluation model 440, and send the recommended test parameter to an interaction module; and obtain an operation instruction of a user through the interaction module, determine a target recommended test parameter based on the operation instruction, and determine the target recommended test parameter as the test parameter 460 of the newly added extended test.

A first predetermined condition refers to a determination condition for evaluating whether the test parameter of the newly added extended test needs to be redetermined. For example, the first predetermined condition may include that the current curve fitness is less than a fitness threshold, etc. The fitness threshold may be a system default value, a system predetermined value, etc.

A test parameter evaluation model refers to a model used to determine the curve fitness.

In some embodiments, the test parameter evaluation model may be a machine learning model. For example, the test parameter evaluation model may be any one or a combination of various feasible models such as a Recurrent Neural Network (RNN) model, a Deep Neural Network (DNN) model, a Convolutional Neural Network (CNN) model, or the like.

In some embodiments, as illustrated in FIG. 4, an input of the test parameter evaluation model 440 may include the candidate material parameter 431, the candidate disturbance parameter 432, the candidate environmental regulation parameter 433, and the wood-based material feature 434, and an output of the test parameter evaluation model 440 may include a curve fitness 450.

The candidate material parameter refers to a material parameter used to determine the recommended test parameter.

The candidate disturbance parameter refers to a disturbance parameter used to determine the recommended test parameter.

The candidate environmental regulation parameter refers to an environmental regulation parameter used to determine the recommended test parameter.

In some embodiments, the candidate material parameter may be determined based on manual input. For example, the candidate material parameter may be determined by the user based on an elastic coefficient of a spring and a damping coefficient of a damper already existing in the test.

In some embodiments, the candidate disturbance parameter may be determined based on manual input. For example, the candidate disturbance parameter may be determined by the user based on a disturbance parameter provided by a disturbance module in the test.

In some embodiments, the candidate environmental regulation parameter may be determined based on manual input. For example, the candidate environmental regulation parameter may be determined by the user based on an adjustable parameter provided by an environmental regulation device in the test. The adjustable parameter may include a range and a gear (e.g., a first gear, a second gear, etc.) of a parameter (e.g., a temperature and a vacuum degree) that may be regulated.

In some embodiments, the test parameter evaluation model may be trained in various feasible ways based on a large number of first training samples with first labels. For example, parameters may be updated based on gradient descent. An exemplary training process may include the following operations. A plurality of the first training samples with the first labels may be input into an initial test parameter evaluation model. A loss function may be constructed by the first labels and results of the initial test parameter evaluation model. Parameters of the initial test parameter evaluation model may be iteratively updated by the gradient descent or other methods based on the loss function. Training of the model may be completed when a predetermined condition is satisfied, and a trained test parameter evaluation model may be obtained. The predetermined condition may include that the loss function converges, a count of iterations reaches a threshold, etc.

In some embodiments, the first training samples may include a plurality of sets of training samples. Each set of training samples may include at least a sample wood-based material feature, a sample candidate material parameter, a sample candidate disturbance parameter, and a sample candidate environmental regulation parameter. The first training samples may be obtained based on historical data.

In some embodiments, a first label may include a curve fitness between an actual predetermined vibration curve corresponding to the set of training samples and a standard vibration curve. For example, the processor may determine the curve fitness to obtain the first label based on similar calculations of the curve similarity, the numerical similarity, or the like, as described above.

An actual predetermined vibration curve refers to a predetermined vibration curve obtained after an actual test is performed based on the set of training samples.

A recommended test parameter refers to a test parameter used to determine the target recommended test parameter.

In some embodiments, the processor may arrange and combine the wood-based material feature, the candidate material parameter, the candidate disturbance parameter, and the candidate environmental regulation parameter to obtain a plurality of sets of parameters, execute, based on each set of parameters, the test parameter evaluation model separately to obtain a corresponding curve fitness, and determine a set of parameters whose curve fitness is greater than a fitness threshold as the recommended test parameters of the newly added extended test.

The target recommended test parameter refers to a test parameter of the newly added extended test determined by the user.

The control instruction of the user refers to an instruction used to select the recommended test parameter on the interaction module. In some embodiments, the user may perform a physical operation related to the selection of the recommended test parameter on the interaction module. The processor may capture the related physical operation to determine the operation instruction of the user. For example, the operation of the user may be an operation of inputting the selection on the interaction module in various ways (including, but not limited to, a text, a voice, a touch screen, etc.) through various input windows of an application, applet, webpage, etc., on the interaction module.

In some embodiments, the processor may send the recommended test parameters to the interaction module for display. The user may select the target recommended test parameter from the displayed set or sets of recommended test parameters through an input component (e.g., a mouse and touch screen).

In some embodiments of the present disclosure, the curve fitness may be determined by the test parameter evaluation model, so that the accuracy and efficiency of determining the curve fitness may be improved using the self-learning capability of the machine learning model; and the target recommended test parameter may be determined based on manual input, so that the determined test parameter of the newly added extended test may be more realistic.

In some embodiments, the processor may generate the corresponding control instruction based on the test parameter of the newly added extended test to be sent to at least one of the interaction module, the force application module, and the environmental regulation device. For example, the processor may extract, based on the test parameter of the newly added extended test, a keyword to determine an object to send. For example, when the keyword is “replacing a model hardware” (e.g., a spring, a damper, etc.), the processor may send the test parameter of the newly added extended test to the interaction module to prompt the user to replace the relevant model hardware through a display screen and/or a loudspeaker playback, thereby guiding the user to perform adjustment. Merely by way of example, when the keyword is “adjusting a disturbance parameter of the force application module and an environmental condition parameter of the environmental regulation device,” the processor may generate, based on a test parameter of the newly added extended test, a corresponding test instruction to be sent to the force application module or the environmental regulation device to control the force application module or the environmental regulation device to make adjustment based on respective parameters.

In some embodiments of the present disclosure, the test parameter of the newly added extended test may be determined by the labeled parameter set and the wood-based material feature, and comprehensive information of each test may be obtained based on the completely executed tests, so that the cause of the data errors (e.g., the disturbance force is too small, and the elastic coefficient of the spring is too small) may be determined, thereby improving the accuracy of the determined test parameter of the newly added extended test.

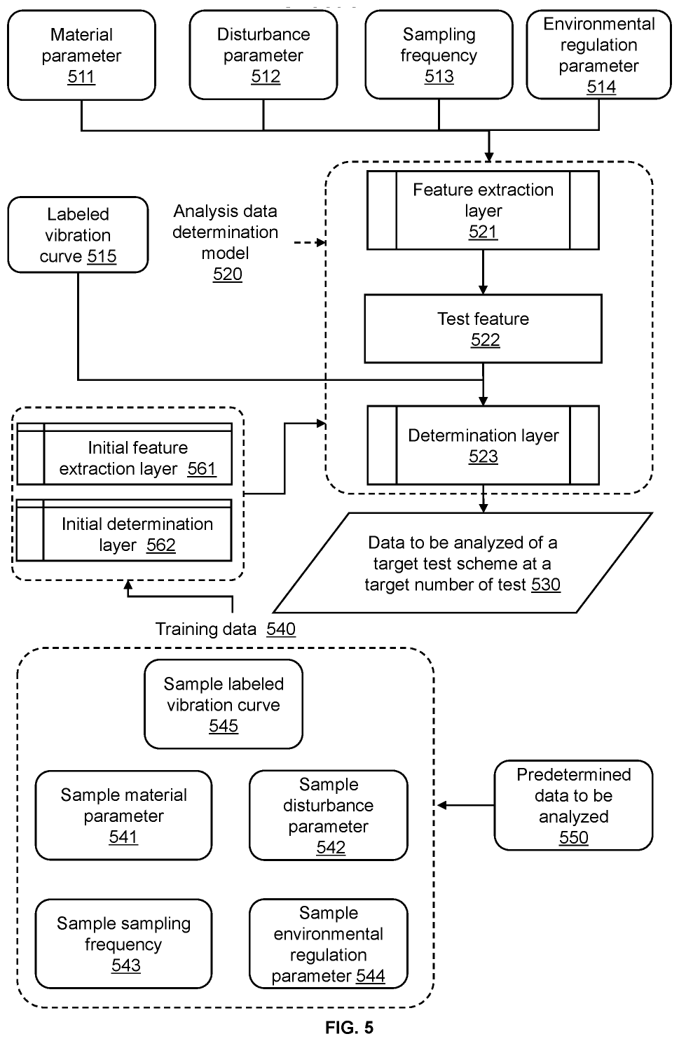

FIG. 5 is a schematic diagram illustrating an exemplary analysis data determination model according to some embodiments of the present disclosure.

In some embodiments, as illustrated in FIG. 5, a processor may obtain, based on a storage module, a labeled vibration curve 515 of a target test scheme; determine, based on a material parameter 511, a disturbance parameter 512, a sampling frequency 513, and an environmental regulation parameter 514 of the target test scheme, a test feature 522 through a feature extraction layer 521 of an analysis data determination model 520; and determine, based on the test feature 522 and the labeled vibration curve 515 of the target test scheme, data to be analyzed 530 of the target test scheme at a target number of test through a determination layer 523 of the analysis data determination model 520.

An analysis data determination model refers a model for determining the data to be analyzed of the target test scheme. In some embodiments, the analysis data determination model may be a machine learning model. For example, the analysis data determination model may be a machine learning model with a customized structure as described below. The analysis data determination model may also be a machine learning model with another structure, such as a Neural Network (NN) model, a Recurrent Neural Network (RNN) model, etc.

In some embodiments, the analysis data determination model may include the feature extraction layer and the determination layer.

A feature extraction layer refers to a model used to determine the test feature. In some embodiments, the feature extraction layer may be a Convolutional Neural Network (CNN), etc.

In some embodiments, an input of the feature extraction layer may include the material parameter, the disturbance parameter, the sampling frequency, and the environmental regulation parameter of the target test scheme, and an output of the feature extraction layer may include the test feature.

A target test scheme refers to a test scheme that needs to perform repeated damping tests for multiple times.

A labeled vibration curve of a target test scheme refers to a predetermined vibration curve for a same wood-based material obtained after historical times of tests are performed based on a same test scheme. Historical times of tests refer to damping tests that are executed completely before the target number of test and corresponding test data is obtained. A target number of test refers to a damping test that is re-executed once based on previously executed tests for a same target test scheme.

Merely by way of example, if five damping tests need to be executed based on the target test scheme, and first, second, third, and fourth damping tests are executed completely, the labeled vibration curve may include a predetermined vibration curve corresponding to each of the first, second, third, and fourth damping tests.

It should be noted that when repeated damping tests need to be performed on the wood-based material for multiple times based on the same test scheme, the damping test system for the wood-based material based on full sampling of the free vibration curve may determine data to be analyzed of the damping test by executing the process 300 after the first damping test is completed. In each subsequent damping test, the predetermined vibration curves corresponding to the previous tests of the damping test and the material parameters, the disturbance parameters, the sampling frequencies, and the environmental regulation parameters of the same test scheme may be obtained, and the data to be analyzed may be determined based on the analysis data determination model.

A determination layer refers a model used for determining the data to be analyzed of the target test scheme. In some embodiments, the determination layer may be a Neural Network (NN) model, or the like.

In some embodiments, an input of the determination layer may include the test feature and the labeled vibration curve of at least one target test scheme, and an output of the determination layer may include the data to be analyzed of the target test scheme at the target number of test.

Data to be analyzed of a target test scheme at a target number of test refers to data to be analyzed obtained after the target number of damping test is executed based on the target test scheme.

In some embodiments, the analysis data determination model may be obtained by jointly training the feature extraction layer and the determination layer based on a large number of second training samples with second labels. Joint training may include gradient descent, etc. More descriptions regarding the joint training may be found in the relevant descriptions below.

In some embodiments, as illustrated in FIG. 5, the processor may obtain a plurality of sets of second training samples which include training data 540 and second labels 550. The training data 540 may include a sample labeled vibration curve 545, a sample material parameter 541, a sample disturbance parameter 542, a sample sampling frequency 543, and a sample environmental regulation parameter 544 of a sample target test scheme. The second labels may characterize predetermined data to be analyzed 550 obtained after a predetermined processing is performed on a sample vibration curve of the sample target test scheme.

Training samples refer to at least a portion of sample sets used to train an initial feature extraction layer and an initial determination layer. In some embodiments, the processor may obtain the initial feature extraction layer and the initial determination layer from the storage module and/or an external data source via a network.

In some embodiments, initial parameters of the initial feature extraction layer and the initial determination layer may be set based on a processor default setting.

A sample target test scheme refers to test scheme that needs to perform repeated damping tests for multiple times. A sample labeled vibration curve refers to a predetermined vibration curve for a same wood-based material obtained after historical times of tests are performed based on a same sample target test scheme.

In some embodiments, the training data may be obtained based on historical data or experiments. For example, the damping test may be repeated multiple times for a plurality of the wood-based materials based on different test schemes, respectively. For each of the plurality of the wood-based materials, each test scheme for the wood-based material may be used as the sample target test scheme. The predetermined vibration curve based on the sample target test scheme at the historical number of test may be obtained as the sample labeled vibration curve of the sample target test scheme. The sample labeled vibration curve of the sample target test scheme and the sample disturbance parameter, the sample sampling frequency, and the sample environmental regulation parameter of the sample target test scheme may be used as a set of training data.

A predetermined processing refers to a manner in which the training data is processed. For example, the predetermined processing may include a way of intercepting a sample vibration curve. A sample vibration curve refers to a predetermined vibration curve obtained by performing the target number of test on the wood-based material based on the sample target test scheme.

Predetermined data to be analyzed includes labels of the training data. The predetermined data to be analyzed refers to data obtained by intercepting the sample vibration curve obtained by performing the predetermined processing on the sample target test scheme after the target number of test.

In some embodiments, the predetermined processing may be determined based on historical data or experimentation. For example, the processor may obtain a plurality of experimental vibration curves obtained by repeating a test multiple times based on a same test scheme, obtain a plurality of experimental data to be analyzed through various interception manners (e.g., random interception and interception within different predetermined time ranges), obtain experimental damping ratios corresponding to the plurality of experimental data to be analyzed through a manner similar to determining the spiral curves, calculate an error between each experimental damping ratio and a reference damping ratio, and determine an interception manner corresponding to an experimental damping ratio with a lowest error as the predetermined processing.

Experimental data to be analyzed refers to data to be analyzed obtained by intercepting a plurality of experimental vibration curves for the same test scheme.

More descriptions regarding the experimental vibration curves and experimental damping ratios may be found in FIG. 4 and the relevant descriptions thereof.

In some embodiments, the processor may intercept the sample vibration curve obtained after the target number of test is performed on the sample target test scheme based on the interception manner of the predetermined processing to determine the predetermined data to be analyzed, and label the training data based on the predetermined data to be analyzed to obtain the second labels.

Merely by way of example, as illustrated in FIG. 5, the joint training may include the following operations. The sample material parameters 541, the sample disturbance parameters 542, the sample sampling frequency 543, and the sample environmental regulation parameter 544 of the sample target test scheme may be input into an initial feature extraction layer 561 to obtain a test feature output from the initial feature extraction layer 561. An output of the initial feature extraction layer 561 and the sample labeled vibration curve 545 of the sample target test scheme may be input into an initial determination layer 562 to obtain the data to be analyzed of the target test scheme at the target number of test. A loss function may be constructed based on an output of the initial determination layer 562 and the predetermined data to be analyzed, and parameters of the initial feature extraction layer 561 and parameters of the initial determination layer 562 may be simultaneously updated until a predetermined iteration condition is satisfied to obtain a trained feature extraction layer and a trained determination layer.

A predetermined condition refers to a determination condition that evaluates whether an iteration converges. In some embodiments, the predetermined condition may be that the loss function is less than a threshold, converges, or that a training period reaches a threshold.

In some embodiments of the present disclosure, the joint training of the feature extraction layer and the determination layer is conducive to solving the problem of difficulty in obtaining labels when a prediction model is trained alone, thereby improving the training efficiency of the prediction model, and reducing the training difficulty.

In some embodiments of the present disclosure, the predetermined vibration curve can be efficiently and accurately intercepted through the analysis data determination model to obtain the better data to be analyzed than that empirically intercepted based on manual experience, thereby facilitating the subsequent determination of the spiral curve, facilitating the subsequent calculation of the damping ratio, and improving the calculation accuracy.

In some embodiments, the wood-based material may also be referred to as a mass block m, and a viscoelastic material, all of which may be referred to as the wood-based material. The predetermined model may also be referred to as a viscoelasticity damping model, and a Kelvin-Voigt model, all of which may be referred to as the predetermined model. The logarithmic attenuation value may also be referred to as logarithmic attenuation, all of which may be referred to as the logarithmic attenuation value. The damping performance may also be referred to as the damping properties, all of which may be referred to as the damping performance. The damping test may also be referred to as a vibration damping test, all of which may be referred to as the damping test. The predetermined vibration curve may also be referred to as a typical dynamic response, and a typical free vibration curve, all of which may be referred to as the predetermined vibration curves. The spiral curve may also be referred to as a dynamic response in a phase plane, all of which may be referred to as the spiral curve. The intrinsic frequency may also be referred to as an undamped vibration frequency and a vibration frequency, all of which may be referred to as the intrinsic frequency.

In order to realize the above purpose, the present disclosure provides a damping test method for a wood-based material based on full sampling of a free vibration curve. The damping test method may comprise the following operations.

S1. A single degree of freedom system may be first formed by a wood-based material mass m attached to a Kelvin-Voigt model. A free vibration of the system in a vertical direction may be caused by an initial disturbance, and sampled to obtain a typical free vibration curve.

S2. Logarithmic attenuation δ may be calculated: an appropriate range of data may be Intercepted. The free vibration may be denoted in terms of x and \dot{x}/ω_{d}, to plot a spiral curve asymptotically close to an origin. A radius R of the spiral curve may be calculated. A linear regression analysis of InR and time t may be performed to calculate a slope and a damping ratio ζ.

Preferably, the wood-based material may include but not limited to: solid wood, an MDF, a particle board, a wood-plastic composite material, glued wood, and a bamboo wood fiberboard.

Preferably, in the operation S1, in order to sense the vibration, an accelerometer may be glued to the other end of the system on which no disturbance is applied. Data sampling may be performed using an A/D data acquisition board. A/D conversion and data transmission may be performed to obtain a typical free vibration curve.

Preferably, in the operation S1, a length of the wood-based material may be within a range of 600-2400 mm, a width of the wood-based material may be within a range of 30-60 mm, and a thickness of the wood-based material may be within a range of 15-30 mm.

Further preferably, the length of the wood-based material may be 1245 mm, the width of the wood-based material may be 45.5 mm, and the thickness of the wood-based material may be 25.4 mm.

Preferably, in the operation S1, a sampling frequency may be within a range of 50-200 kHz. Further preferably, the sampling frequency may be 125 kHz.

Preferably, in the operation S2, data of sampling points located between T₁ and T₂ may be intercepted, wherein T1=0.018 s, and T2=0.028 s.

Preferably, in the operation S2, the radius R of the spiral curve may be represented by:

$$R = \sqrt{{x}^{2} + {( \frac{\dot{x}}{{ϖ}_{d}} )}^{2}} ; \qquad ( 11 )$$

$$R = {{Ae}^{- {ζϖ}_{n} i} [ 1 + {ζ}^{2} {cos}^{2} ( {ϖ}_{d} t - θ ) + ζ \sqrt{1 - {ζ}^{2}} sin ( 2 {ϖ}_{d} t - 2 θ ) ]}^{1 / 2} ; \qquad ( 12 )$$

For most materials including the wood-based material, usually the damping ratio ζ is less than 0.02, and then the equation (12) may be expressed as an equation (13) with an error of no more than 1%:

$$R = {Ae}^{- {ζϖ}_{n} i} ; \qquad ( 13 )$$

$$ln R = ln A - {ζϖ}_{n} t ; \qquad ( 14 )$$

Wherein R denotes the radius of the spiral curve, x denotes a movement distance along a vibration direction of vibration during a vibration process, \dot{x} denotes a movement speed along the vibration direction during the vibration process, ω̅_{d} denotes the damped vibration frequency, A denotes a peak amplitude, ζ denotes the damping ratio, and t denotes the time.

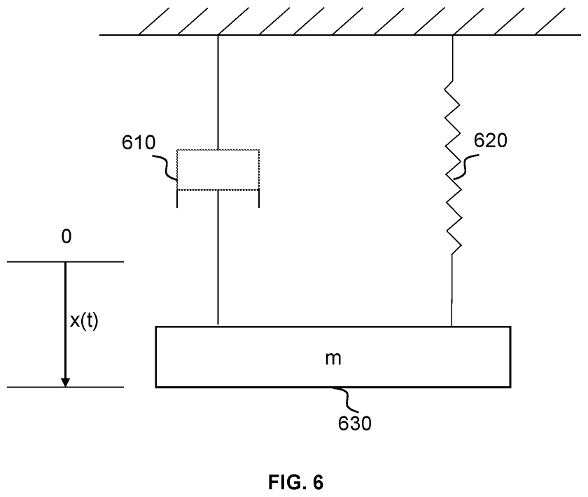

Kinetic properties of wood and other viscoelastic materials may be usually simplified and analyzed as the single degree of freedom system consisting of the mass m attached to a Kelvin-Voigt model (as illustrated in FIG. 6).

FIG. 6 is a schematic diagram illustrating an exemplary viscoelasticity damping model according to some embodiments of the present disclosure. As illustrated in FIG. 6, a damper 610 and a spring 620 may be connected in series to form a Kelvin-Voigt model. A mass 630 may be suspended in the air through the Kelvin-Voigt model. A one-dimensional coordinate system may be established in a vertical direction. An origin O represents a position of the mass 630 when the damper 610 and the spring 620 are not subjected to a force, and x(t) denotes a free vibration displacement of the mass 630 in the vertical direction after an initial disturbance is applied to the mass 630.

The free vibration of the system in the vertical direction due to the initial disturbance may be described, based on Newton's law, as equation (1):

$$\ddot{x} + 2 {ζϖ}_{n} \dot{x} + {ϖ}_{n}^{2} x = 0 ; \qquad ( 1 )$$

$${ϖ}_{n} = {( k / m )}^{1 / 2} ; \qquad ( 2 )$$

$$ζ = c / 2 m {ω}_{n} = c / 2 \sqrt{mk} ; \qquad ( 3 )$$

Wherein c denotes a damping constant, k denotes an elasticity constant, ωₙ denotes an intrinsic frequency, and ζ denotes a damping ratio.

For wood and other viscoelastic materials, ζ<1, i.e., c²<4 mk, the equation (1) may be generalized to an equation (4):

$$x ( t ) = {Ae}^{- {ζϖ}_{n} i} cos ( {ϖ}_{d} t - θ ) ; \qquad ( 4 )$$

$${ϖ}_{d} = {{ϖ}_{n} ( 1 - {ζ}^{2} )}^{1 / 2} ; \qquad ( 5 )$$

$$A = \sqrt{{x}_{0}^{2} + {( \frac{{x}_{0} {ζϖ}_{n} + {\dot{x}}_{0}}{{ϖ}_{d}} )}^{2}} ; \qquad ( 6 )$$

$$cos θ = {x}_{0} / A ; \qquad ( 7 )$$

Wherein x₀ and \dot{x}₀ denote an initial position and an initial speed at t=0, ω_{d} denotes the damped vibration frequency, and A denotes the peak amplitude.

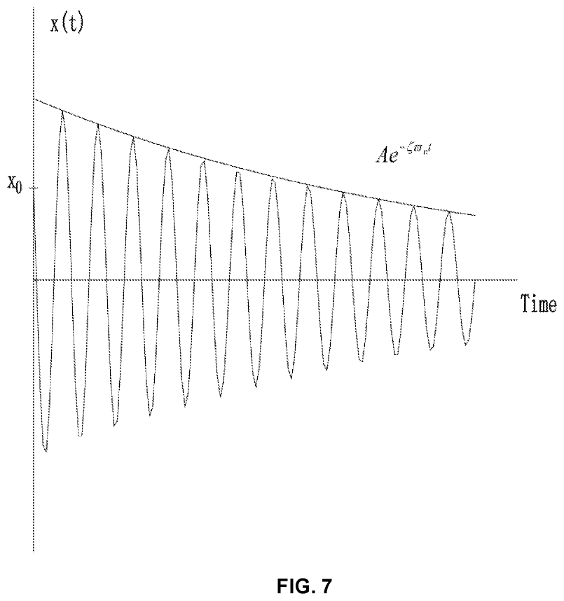

A typical case of a free vibration of the viscoelastic material in a time domain shown in the equation (4) may be shown in FIG. 7.

FIG. 7 is a schematic diagram illustrating an exemplary typical dynamic response according to some embodiments of the present disclosure. As illustrated in FIG. 7, a horizontal axis represents time, and a vertical axis represents the movement distance x(t) that the mass moves along the vertical direction during the free vibration.

The classical technique most widely used for determining damping is to measure logarithmic attenuation by definition:

$$δ = \frac{1}{n} ln \frac{{A}_{1}}{{A}_{n + 1}} ; \qquad ( 8 )$$

Wherein δ denotes the logarithmic attenuation, and A₁ and Aₙ₊₁ denote two peak amplitudes spaced apart by n oscillation periods on a free vibration curve. The damping properties may be calculated only using the peak amplitudes in this calculation method.

When the logarithmic attenuation δ is represented as a natural logarithm of a ratio of the two consecutive peak amplitudes, a relationship between the logarithmic attenuation and the damping ratio may be represented by an equation (9):

$$δ = ln ( {e}^{{ζϖ}_{n} T} ) = \frac{2 πζ}{{( 1 - {ζ}^{2} )}^{1 / 2}} ; \qquad ( 9 )$$

$$T = \frac{2 π}{{ϖ}_{d}} ; \qquad ( 10 )$$

If the free vibration is described in terms of x(t) and

$$\frac{\dot{x}}{{ϖ}_{d}} ,$$

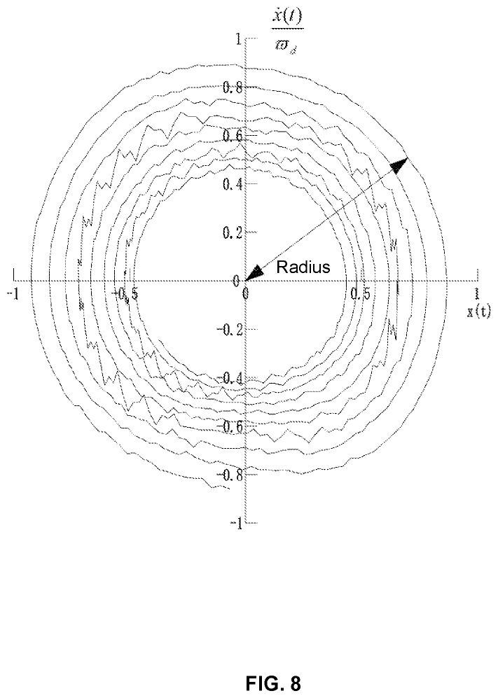

a spiral curve asymptotically close to the origin may be plotted. FIG. 8 illustrates the above type of spiral curve obtained from testing of the MDF.

FIG. 8 is a schematic diagram illustrating an exemplary dynamic response of an MDF in a phase plane according to some embodiments of the present disclosure. As illustrated in FIG. 8, a horizontal axis represents a movement distance x(t) that a mass moves along a vertical direction during a free vibration, and a vertical axis represents

$$\frac{\dot{x}}{{ϖ}_{d}} .$$

A processor may perform fitting based on data to be analyzed to obtain a spiral curve.

A radius R of the spiral curve may be represented by:

$$R = \sqrt{{x}^{2} + {( \frac{\dot{x}}{{ϖ}_{d}} )}^{2}} ; \qquad ( 11 )$$

$$R = {{Ae}^{- {ζϖ}_{n} i} [ 1 + {ζ}^{2} {cos}^{2} ( {ϖ}_{d} t - θ ) + ζ \sqrt{1 - {ζ}^{2}} sin ( 2 {ϖ}_{d} t - 2 θ ) ]}^{1 / 2} ; \qquad ( 12 )$$

For most materials, usually a damping ratio ζ is less than 0.02, and then the equation (12) may be expressed as an equation (13) with an error of no more than 1%:

$$R = {Ae}^{- {ζϖ}_{n} i} ; \qquad ( 13 )$$

$$ln R = ln A - {ζϖ}_{n} t ; \qquad ( 14 )$$

Therefore, a slope may be searched using a simple linear regression analysis, which in turn calculates the damping ratio ζ. In addition, the damping ratio obtained in the present disclosure does not depend on a time interval over which the linear regression analysis is performed when the sample points are selected.

The conventional method uses only the peak amplitude to calculate the damping properties, while the new method proposed in the of the present disclosure uses all the sample points in the time domain to evaluate the error and calculate the damping properties, maximizing the use of the available information to provide more accurate measurements of damping ratios. In addition, the conventional method requires the setting of initial conditions to perform the analysis, while the new method of the present disclosure does not require the setting of initial conditions to determine the damping properties of the structural material, in particular of the wood-based material, and thus more accurately measure the damping properties of the wood-based material. This technical effect of the present disclosure is achieved by calculating the logarithmic attenuation amount by utilizing the new method of the vibration damping test, and determining the damping performance of the material by calculating through theoretical formulas using all sample points in the time domain. The method is capable of maximizing the use of all available information, avoiding the omission of any useful information about damping, and is thus more accurate than the conventional method.

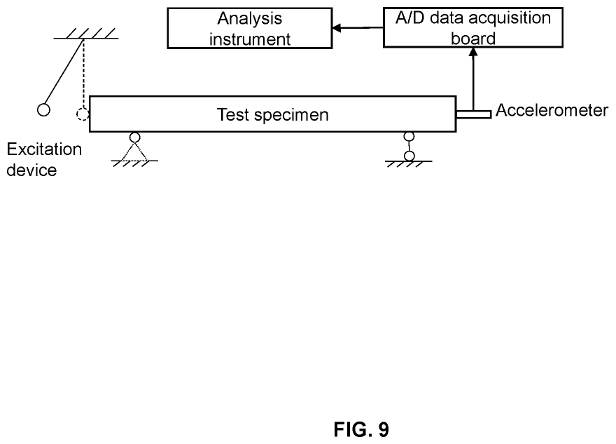

Damping properties of solid wood, an MDF, and a particle board may be tested using the conventional method and the new method of the present disclosure. The schematic diagram illustrating the damping test system may be shown in FIG. 9.

The conventional method uses the equation (8) to perform calculation, which uses only the peak amplitude to calculate the damping properties of the material. In contrast, the new method of the present disclosure proposes a completely new way of calculation, which first selects all sample points based on an entire waveform of a vibration signal to calculate the radius R of the spiral curve through the equation (11), and then uses a simple linear regression analysis to search the slope through the equation (14), which in turn calculates the damping ratio ζ, thus obtaining a more accurate result. The new method of the present disclosure is capable of reflecting the damping properties of the material in a more comprehensive way, thereby avoiding the errors that may arise from the calculation method only based on the peak amplitude.

FIG. 9 is a schematic diagram illustrating an exemplary damping test system according to some embodiments of the present disclosure. As illustrated in FIG. 9, when a pendulum is released and strikes one end of a test specimen, a longitudinal stress wave may be generated to test damping properties of a material. The stress wave is formed by the superposition of a plurality of harmonic vibrations. A fundamental vibration of the test specimen may be described by the equation (4). In order to sense the vibration, an accelerometer may be glued to the other end of the test specimen with a hot melt adhesive, and data may be sampled at a rate of up to 10⁶ Hz using an A/D data acquisition board and may be stored in a storage for up to one million samples. A/D conversion and data transmission may be completed using software. A vibration frequency and logarithmic attenuation may be calculated by the conventional and new methods, and results may be displayed on a computer screen.

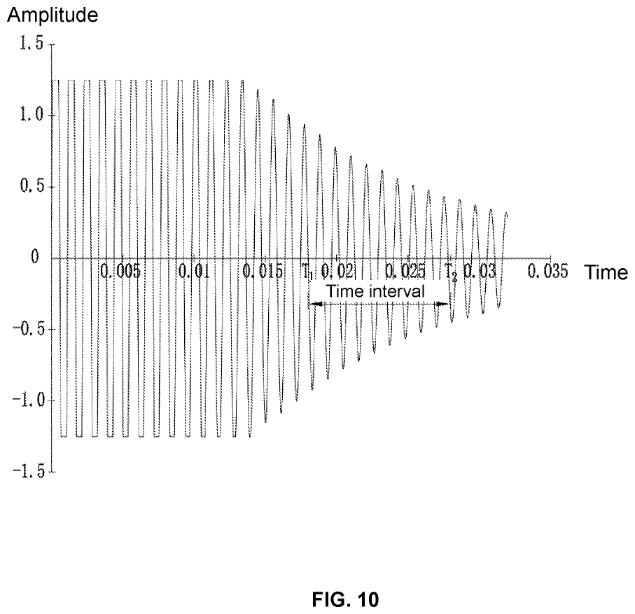

FIG. 10 is a schematic diagram illustrating an exemplary typical free vibration curve of an MDF according to some embodiments of the present disclosure. As illustrated in FIG. 10, a vertical axis represents an amplitude, i.e., a movement distance x(t) of the MDF along a vertical direction during a free vibration, and a horizontal axis represents time. FIG. 10 illustrates the typical free vibration curve of the MDF (1245 mm long, 44.5 mm wide, and 25.4 mm thick), with a sampling frequency of 125 kHz, and a total of 4000 sampling points. A schematic diagram of a computer program for analyzing the data is shown in FIG. 6. Although a damping ratio of a viscoelastic material modeled through a single degree of freedom system does not depend on the selection of a time interval, a current experiment may use sampling points located between T₁ and T₂ (see FIG. 5) since the data prior to T₁ are typically affected by transient shock from a pendulum and a higher resonance signal, and the data after T₂ are affected by circuit noise (with a relatively low signal-to-noise ratio). The current experiment may use a value of 0.018 s for T₁ and 0.028 s for T₂. Mean logarithmic attenuation (based on five experiments) and a coefficient of variation may be shown in Table 1.

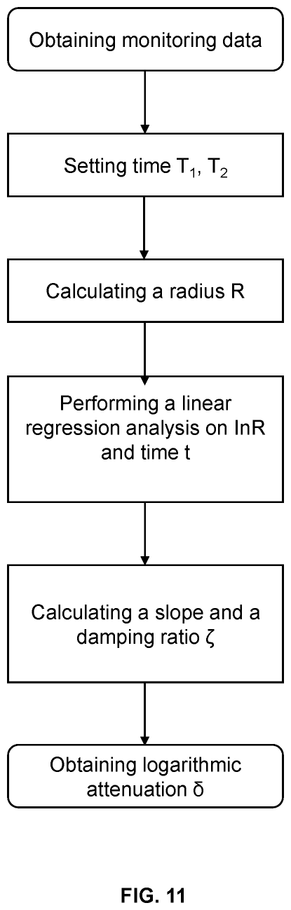

FIG. 11 is a schematic diagram illustrating an exemplary damping test based on full sampling according to some embodiments of the present disclosure. As illustrated in FIG. 11, a processor may obtain, through an analog-to-digital converter, an acceleration of a wood-based material monitored by a data monitoring module; obtain, based on the acceleration and in a manner similar to the fitting in FIG. 3, a predetermined vibration curve; intercept, based on the predetermined vibration curve, data of sampling points between T₁ and T₂ as data to be analyzed; determine, based on the data to be analyzed and in a manner similar to that in FIG. 3, a spiral curve; calculate, based on the spiral curve, a radius of the spiral curve; and determine, based on a linear expression between a natural logarithm of the radius and a damping ratio, a slope and the damping ratio through a linear regression analysis, and then determine a logarithmic attenuation value.

TABLE 1
Logarithmic attenuation results obtained using the new method of the
present disclosure and the conventional method

| | Logarithmic attenuation | | | |
|---|---|---|---|---|
| | New method | | Conventional method | |
| | Mean | Coefficient | Mean | Coefficient |
| | logarithmic | of | logarithmic | of |
| Material | attenuation | variation | attenuation | variation |
| Solid | 0.0347 | 0.0151 | 0.0363 | 0.0214 |
| wood | | | | |
| MDF | 0.0798 | 0.0266 | 0.0822 | 0.0846 |
| Particle | 0.0661 | 0.0191 | 0.0650 | 0.0803 |
| board | | | | |

The experimental results indicate that the quality of a free vibration curve of the solid wood is better than that of the MDF and the particle board, and a relatively large number of peaks are used in the conventional method (due to less damping). Therefore, there is no significant difference in the logarithmic attenuation obtained by the calculations of the new method and the conventional method, but the coefficients of variation calculated by the new method are smaller than those of the conventional method, indicating a lower degree of sample dispersion. In the case of the MDF and the particle board, which have poorer quality of the free vibration curves and higher damping, the new method of the present disclosure has significant advantages of a smaller coefficient of variation and a higher consistency and repeatability in the logarithmic attenuation than that of the conventional method. To sum up, the new method of the present disclosure evaluates the error by fully utilizing all the sampling points in the time domain, provides more accurate damping measurements, and is capable of determining the damping performance of a structural material without setting the initial conditions, which is valuable for practical applications.

One or more embodiments of the present disclosure further provide a damping test device for a wood-based material based on full sampling of a free vibration curve. The damping test device may comprise a processor configured to implement the damping test method for the wood-based material based on full sampling of the free vibration curve as described in any one of the above embodiments.

One or more embodiments of the present disclosure further provide a non-transitory computer-readable storage medium comprising computer instructions that, when read by a computer, may direct a processor to run the damping test method for the wood-based material based on full sampling of the free vibration curve.

The basic concept has been described above. Obviously, for those skilled in the art, the above detailed disclosure is only an example, and does not constitute a limitation to the present disclosure. Although not expressly stated here, those skilled in the art may make various modifications, improvements and corrections to the present disclosure. Such modifications, improvements and corrections are suggested in this disclosure, so such modifications, improvements and corrections still belong to the spirit and scope of the exemplary embodiments of the present disclosure.

Meanwhile, the present disclosure uses specific words to describe the embodiments of the present disclosure. For example, “one embodiment”, “an embodiment”, and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures, or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This method of disclosure does not, however, imply that the subject matter of the disclosure requires more features than are recited in the claims. Rather, claimed subject matter may lie in less than all features of a single foregoing disclosed embodiment.

In some embodiments, counts describing the quantity of components and attributes are used. It should be understood that such counts used in the description of the embodiments use the modifiers “about”, “approximately” or “substantially” in some examples. Unless otherwise stated, “about”, “approximately” or “substantially” indicates that the stated figure allows for a variation of ±20%. Accordingly, in some embodiments, the numerical parameters used in the disclosure and claims are approximations that can vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A damping test system for a wood-based material based on full sampling of a free vibration curve, comprising:
a damping test device, a carrying space, a processor, and a storage module, wherein the damping test device is located in the carrying space, and the damping test device includes a viscoelasticity test module, a force application module, and a data monitoring module; the viscoelasticity test module includes at least a single degree of freedom system formed based on a predetermined model, the wood-based material is arranged on the pre-determined model, and the processor is integrated in a processing terminal, and the processor is configured to:
generate a test scheme and execute a test corresponding to the test scheme, the test including an initial test and/or an extended test;
obtain a labeled test scheme, the labeled test scheme indicating that the test corresponding to the test scheme is executed;
determine, based on the labeled test scheme, test data of the labeled test scheme, the test data including at least a logarithmic attenuation value of the labeled test scheme;
determine, based on the test data, whether the extended test is added;
in response to determining that the extended test is added, adjust, based on the test data obtained from the storage module, a sampling frequency of the data monitoring module, determine a test parameter of a newly added extended test, and send the sampling frequency and the test parameter to the storage module for storage, the test parameter of the newly added extended test including at least one of a material parameter of a model hardware and a disturbance parameter of the force application module, and the material parameter of the model hardware including at least one of an elastic coefficient of a spring and a damping coefficient of a damper; and
generate, based on the test parameter of the newly added extended test and an adjusted sampling frequency, a new test scheme, the new test scheme being configured to perform a damping test on the wood-based material.

2. The damping test system of claim 1, wherein the wood-based material includes at least one of solid wood, a medium density fiberboard, a particle board, a wood-plastic composite material, glued wood, and a bamboo wood fiberboard.

3. The damping test system of claim 1, wherein the data monitoring module includes an accelerometer, the accelerometer is mounted on a side of the wood-based material opposite to a force side, and the processor is configured to obtain, through an analog-to-digital converter, an acceleration of the wood-based material measured by the accelerometer during a free vibration process; and
the processor is further configured to:
obtain, based on the acceleration, a predetermined vibration curve by fitting.

4. The damping test system of claim 1, wherein a length of the wood-based material is within a range of 600-2400 mm, a width of the wood-based material is within a range of 30-60 mm, and a thickness of the wood-based material is within a range of 15-30 mm.

5. The damping test system of claim 1, wherein the sampling frequency is within a range of 50-200 KHz.

6. The damping test system of claim 1, wherein the processor is further configured to:
generate a control instruction based on the test scheme, the control instruction being configured to control the damping test device to perform a damping test, and the control instruction including the test parameter;
obtain monitoring data of the wood-based material through the data monitoring module during a process of the damping test;
generate, based on the monitoring data, a predetermined vibration curve and send the predetermined vibration curve to the storage module for storage, the predetermined vibration curve being obtained by sampling a free vibration of the wood-based material by the data monitoring module, and the free vibration being generated by applying an initial disturbance in a specified direction to the wood-based material by the force application module;
determine, based on the predetermined vibration curve, data to be analyzed; and
determine, based on the data to be analyzed, the logarithmic attenuation value and send the logarithmic attenuation value to the storage module for storage, and label the test scheme.

7. The damping test system of claim 6, wherein the data to be analyzed is data intercepted from a sampling point located between T1 and T2, T1=0.018 s, and T2=0.028 s.

8. The damping test system of claim 6, wherein the processor is further configured to:
obtain, based on the data to be analyzed, a spiral curve by fitting.

9. The damping test system of claim 1, further comprising an interaction module and an environmental control device, wherein the environmental control device is located in the carrying space, and the interaction module is integrated in the processing terminal;
the interaction module is configured to push prompting information to a user and obtain an operation feedback from the user, and the environmental control device is configured to control, based on an environmental control parameter, an environment within the carrying space; the test parameter of the newly added extended test further includes the environmental control parameter; and the processor is further configured to:
for at least one test of at least one labeled test scheme,
determine, based on a labeled vibration curve, a labeled logarithmic attenuation value, a labeled damping ratio, a labeled material parameter, a labeled disturbance parameter, and a labeled sampling frequency obtained from the storage module, and a wood-based material feature, the test parameter of the newly added extended test; and
send the test parameter of the newly added extended test to at least one of the interaction module, the force application module, and the environmental control device.

10. The damping test system of claim 9, wherein the processor is further configured to:
determine, based on the labeled vibration curve, the labeled logarithmic attenuation value, the labeled damping ratio, the labeled material parameter, the labeled disturbance parameter, the labeled sampling frequency, and the wood-based material feature, a current curve fitness; and
determine, based on the current curve fitness, the test parameter of the newly added extended test.

11. The damping test system of claim 10, wherein the processor is further configured to:
in response to determining that the current curve fitness satisfies a first predetermined condition, determine, based on a candidate material parameter, a candidate disturbance parameter, a candidate environmental control parameter, and the wood-based material feature, a recommended test parameter of the newly added extended test through a test parameter evaluation model, and send the recommended test parameter to the interaction module, the test parameter evaluation model being a machine learning model; and
obtain an operation instruction of the user through the interaction module, determine, based on the operation instruction, a target recommended test parameter, and determine the target recommended test parameter as the test parameter of the newly added extended test.

12. The damping test system of claim 1, wherein the processor is further configured to:
obtain, based on the storage module, a labeled vibration curve of a target test scheme;
determine, based on a material parameter, a disturbance parameter, a sampling frequency, and an environmental control parameter of the target test scheme, a test feature by a feature extraction layer of an analysis data determination model; and
determine, based on the test feature and the labeled vibration curve of the target test scheme, data to be analyzed of a target number of test of the target test scheme by a determination layer of the analysis data determination model.

13. The damping test system of claim 12, wherein the processor is further configured to:
obtain a plurality of sets of training samples, wherein for each training sample, the training sample includes training data and a corresponding label, the training data includes a sample labeled vibration curve of a sample target test scheme, a sample material parameter, a sample disturbance parameter, a sample sampling frequency, and a sample environmental control parameter, and the label characterizes predetermined data to be analyzed obtained by a predetermined processing of the sample vibration curve of the sample target test scheme at the target number of test;
jointly train, based on the plurality of sets of the training samples, the feature extraction layer and the determination layer to obtain the analysis data determination model; wherein the jointly training includes:
for the each training sample, inputting the sample material parameter of the sample target test scheme, the sample disturbance parameter, the sample sampling frequency, and the sample environmental control parameter of the training sample into an initial feature extraction layer to obtain a test feature output from the initial feature extraction layer, inputting an output of the initial feature extraction layer and the sample labeled vibration curve into an initial determination layer to obtain the data to be analyzed of the target test scheme at the target number of test; constructing, based on the output of the initial determination layer and the predetermined data to be analyzed, a loss function, and simultaneously updating a parameter of the initial feature extraction layer and a parameter of the initial determination layer until a predetermined iteration condition is satisfied to obtain a trained feature extraction layer and a trained determination layer.

14. The damping test system of claim 1, wherein the processor is further configured to:
in response to determining that a data volume of data to be analyzed satisfies a second predetermined condition, adjust, based on the data volume of the data to be analyzed and the sampling frequency of the labeled test scheme, the sampling frequency of the newly added extended test and send the adjusted sampling frequency of the newly added extended test to the data monitoring module and/or upload the adjusted sampling frequency of the newly added extended test to the storage module.
